(19) United States
(12) Patent Application Publication
(10) Pub. No.: US 2007/0156692 A1
(43) Pub. Date: Jul. 5, 2007

(54) Essential data communication system

(76) Inventor: Richard Rosewarne, Balwyn East (AU)

Correspondence Address: INNOVAR, LLC, P O BOX 250647, PLANO, TX, 75025, US

(21) Appl. No.: 11/510,492

(22) Filed: Aug. 25, 2006

Related U.S. Application Data
(63) Continuation-in-part of application No. PCT/AU05/00267, filed on Feb. 25, 2005.

(30) Foreign Application Priority Data
Feb. 25, 2004 (AU) 2004/900966

(51) Int. Cl. G06F 17/30; G08B 23/00

(52) U.S. Cl. 707/9; 340/573.1

(57) ABSTRACT

The present invention provides a communication system forming a safety mechanism for people likely to be disoriented or lost. Using the system, a user provides personal details and defines access restrictions for that data. The access restrictions can include predefined events such s the user being reported lost. The data is disseminated to specified recipients, such as emergency services and police, when conditions of the access restrictions are met. The system has particular application to the location of missing persons.

### CROSS-REFERENCE TO EARLIER FILED APPLICATIONS

The present application is related to and claims priority from Australian Provisional Patent Application No. 2004900966, filed 25 Feb. 2004, entitled “Essential Data Communication System,” which is hereby incorporated by reference in its entirety. The present application is a continuation-in-part of PCT International Patent Application No. PCT/AU2005/000267 filed Feb. 25, 2005, the entire disclosure of which is hereby incorporated by reference.

### FIELD OF THE INVENTION

This invention relates to a system of communication of essential data. It is particularly related to a system for locating missing persons and a system for medical assistance and self-management but is not limited to such.

### BACKGROUND ART

It is known for information to be included on databases and the access to that database to be defined by a body in authority such as police, government department or essential services. However it has long been understood that the information of the user is entered by a first person for one reason according to the prejudices of that person and used for another reason and interpreted according to the prejudices of the second person. Often the user has had no control of the input of the information or able to check for its validity, yet the consequences can be embarrassing, unfair or cause severe financial or health disability.

Currently, there are no statewide or national systems in Australia that can provide the depth and breadth of service offered by the system. Although some local data systems are in operation, these are generally run by volunteers or as an ancillary service. As such, they frequently do not meet the growing demand for professional standards, particularly in relation to a national system with the capacity to provide secure storage of up-to-date information that is readily accessible across all regions of Australia.

Therefore such systems are not applicable to areas of self help or particular prejudices of an individual such as casino credit limitations for uncontrollable gamblers, drink limitations for alcoholics, lost persons aids for aged or dementia or people prone to disorientation, or medical records for ill people. Since the data can be and is often readily misused it is not freely given by the people in need and therefore no safeguard is provided.

Of direct relevance to the system of the invention is that in 1998 the applicant completed a report commissioned by the Victorian Department of Human Services examining “Wandering Behaviour in the Community”. The report focused specifically on the issues faced by people with dementia and their caregivers and provided advice on the ways in which caregivers, Police and Government departments could best respond to this behaviour among at risk people. Currently, the applicant is continuing to undertake health care evaluations in both the aged and community care sectors, while providing and managing the database systems used by Alzheimer's Associations in Australia.

To gain some appreciation for the extent of this problem, it is estimated that up to 25% of all people with memory loss and Alzheimer's disease are at risk of becoming lost or disorientated (Wandering and Dementia; Report to the Health Department of Victoria, Australia 1998).

People with Alzheimer's disease, other forms of dementia, intellectual disability or developmental problems (eg. autism) might become disoriented, confused and be unable to find their way home. They can become lost even in familiar settings such as outside the house in local streets, at a shopping centre, travelling on public transport or on an outing or drive to an unfamiliar place. Wandering can happen at any time or place and can put the individual at risk if they are not located and returned home in reasonable time. Wandering is quite common amongst people with Alzheimer's disease and others types of dementia and can be very worrying for families and caregivers who are concerned for the person's safety and well-being. The person's failing memory, disorientation and declining ability to communicate may make it impossible for them to remember or explain the reason for why they wandered.

People with Alzheimer's disease and other dementias are at risk of wandering and perhaps becoming lost in their surroundings. Some individuals experience agitation and/or restlessness and feel the need to keep moving to alleviate this feeling. This restlessness is frequently goal directed. For instance, the person may wish to revisit a place that holds special memories for them or a place where they felt secure (eg: their old home, previous accommodation or place of work). Knowing about these special places and ensuring that this knowledge is readily available to Police can save vital time in locating a person who is missing.

Reasons for wandering include changed environment, loss of memory, excess energy, expressing boredom, confusing night with day, continuing a habit, agitation, discomfort or pain, a job to perform, dreams, and searching for the past. These reasons are adapted from Alzheimer's Australia Help Sheet.

It is therefore necessary to learn to deal with wandering behaviour. However frequent problems associated with wandering behaviour include that wandering can occur at any time and from a variety of settings including: the residential home, daily activity groups, residential care institutions, shopping centres and recreational outings.

For the parents of children with an intellectual disability, the dilemma is how to encourage independence, creative exploration and enjoyment of the surroundings, while at the same time preventing the child from wandering off and becoming lost. It is frequently not possible to determine what triggers the behaviour or when it will occur.

To the family and caregiver, wandering behaviour can significantly add to their list of daily responsibilities and stress levels. Many caregivers find themselves in the difficult position of having to restrict the independence of their loved one in order to reduce the risk of a missing episode.

Options used to curb wandering behaviour include providing interesting activities and participation, promoting physical activities (under supervision) during afternoon periods, restricting external access if located in a high risk area, constant vigilance, using locks and other devices to keep person in designated setting, and utilising systems or devices to monitor the movement of the person if a persistent wanderer. Each of these options is associated with its own set of advantages and disadvantages, and no one option will be suitable for all individuals. While decisions can be difficult to make, it is important for caregivers to be proactive, not reactive.

Some Proactive Steps towards Dealing with Wandering Behaviour
1. Make the decision to plan for future wandering behaviour;
2. Anticipate issues or problems when the person at risk may be more agitated than usual;
3. Seek out professional advice from support services;
4. Decide on a course of action;
5. Take steps implement the user preferred course of action

Some other issues to consider are the type of disability, the degree of disability, the broader family needs and the types and levels of support that can be provided long term and the personality of the ‘at risk’ person.

U.S. Pat. No. 5,955,952 to Bergman et al. discloses a system whereby an individual provides data to the company that stores the data. If a person goes missing the subscriber phones the company which then communicates the data collected via phone/fax etc to police/emergency services. The system it does not include direct access by police/emergency services, direct access by families, direct communication channels between emergency services and families or a public communication channel via the internet/www.

Other emergency systems are disclosed in U.S. Pat. No. 6,034,605 to March, U.S. Pat. No. 6,581,073 to Adler, and U.S. Pat. No. 6,078,828 to Casey, U.S. Application Publication No. 2002/0116393 to Goldstein, and No. 2004/0225681 to Chaney et al., Japanese publication No. 2002-175390 to Getsuko, and by H. Koshima et al. (Personal Locator Services Emerge (2000), 37(2), 41-48).

The Alzheimer's Association USA maintains a static database kept at a central location. If a person on the database goes missing the ‘carer’ phones the local Alzheimer's branch (in a state) and they call the central office and the central office then faxes the details to the local police involved in the search. The carer, police and local Alzheimer's site have no direct access to the record and the approach does not constitute a software system. The system features include:
No direct access or controlling access to the database record for the consumer/user/family
Consumer/user/family cannot update their details directly into their record
Consumer/user/family cannot post missing person alerts directly from their private web-site areas and get an indication that the alert has been received.
System is not directly linked into Emergency Services intranets and automatically authenticated

U.S. Application Publication No. No. 2002/0016719 to Nemeth collects information directly from the patient via keyboard or an electronic device connected to the patient and then transmits (via wireless data system) the data to be added to the patients remote system medical record. On receipt of the information the server with the patient details determines if the information so analyzed presents the need for a medical alert to be broadcast to a third party. The application covers a broad range of inputs from consumers/users that is linked with information on the patient available from servers to produce and ‘result’ that indicates various actions/advice. The system does not indicate that the consumer/user/family controls the record or has a web viewable interface or can use the record for other personal purposes not specified in the claim

### SUMMARY OF THE INVENTION

It is an object of the invention to provide an assisting system to overcome or ameliorate the above-identified problems.

It is believed there is a need of the community to provide a communication system of essential data that would be freely provided by the people in need to provide a safeguard for the people in need.

The applicant has developed the system after considerable interest, consultation, and advice from a number of peak bodies serving the needs of a range of ‘at risk people’ and their caregivers. Input was also sought and received from the caregivers of ‘at risk’ individuals living in the community.

The system of the invention aims to help support families and caregivers by providing an efficient, secure, and up to date professional internet database service to facilitate the speedy recovery of lost or disorientated ‘at risk’ people.

Exemplary Safe Return Home/ID Assist and Medi-Assist systems of the invention include the user/consumer/family members as the central part of the system model whereby they view their own database information via private web access and control all aspects of the systems including viewing and access by third parties via their secure connection over the internet:
Consumers can enter their data and update at any time via an internet connection
Consumers control who can access their record (containing personal details, photo, medical information, likely location if missing, important contacts, identifying data). Access to others can be removed at the choice of the user/family member but the record remains for their personal use
Consumers control the level of access to the various parts of their record (view/read only/edit/no access)
Consumers can send missing person alerts directly from the system to emergency services such as Police
Consumers can use their record as an information store and health management site and send health alerts to health care services and professionals
Consumers can complete the missing person report via the internet and Emergency Services such as police can access the pro-forma of the missing person report and distribute this directly from the system via email, fax or print out.

SRH/ID Assist/Medi-Assist system of the invention provides consumers/users/family with their ‘own’ web database system that they control—the patient can deny access to their record or parts of the record. The Medi-Assist system comprises a web interface that the consumer/user/family member logs into to include basic information and specific data on various health conditions and health behaviours. Medi-Assist does not need a connection to a third party, hospital or doctor to be effective as it is a record for the consumer that they control.

With Medi Assist system of the invention, the user enters their own health status and measurement information in their record via a direct internet connection (keyboard, mouse) or information/data can be obtained from the patients general practitioner record held at their doctors surgery—this is via a direct upload of data from the GP's software system. The patient and doctor set-up measurement ‘limits’ that are embedded into a patients profile in their computer database area and the measurement readings can be compared to ‘ideal’ levels indicated by the patient and/or doctor—the system has computer algorithms that check the indicated measurements and also refer to state/national clinical guidelines. Unusual readings trigger a response from the Medi-Assist system with advice such as ‘visit your doctor immediately’. It can also send an email or SMS to the treating primary medical practitioner with the data and charted indications. The doctor/nurse can respond the email directly and if they have access, insert a response into the patients own medical record.

The invention provides an essential data communication system for allowing controlled access or communication of essential data of each of a multiple number of users including the steps of:
the user defining an input of essential data and the user defining a control restriction of access to the user's defined essential data;
collating the essential data of multiple users including each user defined control restriction of access to each user's defined essential data, and
communicating or allowing access to a user's defined essential data in accordance with the user's defined control restriction of access to the user's defined essential data.

The essential data can be identification data or identification and medical data.

The user defined control restriction of access to said defined essential data includes automatic selection of access by emergency services including police, ambulance and hospital or selection of access by defined persons. The defined persons can be a caregiver or selected medical practitioner or include an authorised person of an orgainsation such as school or association.

The user defined control restriction of access to said defined essential data can include a predefined event that is defined by one or more conditions or circumstances of the user. The conditions or circumstances of the user include any one or more of medical disability, being reported lost, disorientated or otherwise incapacitated. These conditions can be automatically assessed such as from an evaluation of essential data recorded. However the conditions or a circumstance of the user is assessed from external inputs.

The user defined control restriction of access to said defined essential data can include selecting defined persons able to add or modify the user's essential data. There can be general authorised persons able to add or modify the user's essential data.

For security there can be recordal of occurrence of access to or communication of the user's essential data.

In some embodiments, local organizations can manage the system for users/faiilies by entering data but the user/family still maintains control of the record and access levels. Data entered in the system is available country and world-wide via the initernet.

The essential data entry can include maintaining changes of user's essential data and recordal of said changes for display. The conditions or circumstances of the user can be assessed from an evaluation of the change in essential data recorded or from an evaluation of the change in essential data recorded.

Another aspect of the essential data communication system is that dependent on the conditions or circumstances of the user as assessed a form of the user's essential data is communicated to the user. The defined form of the user's essential data can be automatically communicated to a person as defined in the user's defined control restriction of access to the user's defined essential data. However a selective broadcast can occur to a defined person, association or emergency service defined in the user's defined control restriction of access to the user's defined essential data. Also a general broadcast could occur to a widely accessible or viewable medium defined in the user's defined control restriction of access to the user's defined essential data.

Also in accordance with the invention there is provided a method of data collection and data dissemination with a user defined input, and a user defined control restriction of access to personal data with the access restriction including a predefined event that is not time defined but defined by one or more conditions or circumstances of the user.

The conditions or circumstances can include medical disability, being reported lost. disorientated or otherwise incapacitated.

A method of providing an essential data communication system forming a safety mechanism for people likely to be disorientated or lost, the method including the steps of:

a user or person on behalf of the user providing personal details of the user;

the user authorising recording of the personal data in one or more forms of personal data files having varying amount of details;

the user defining one or more access restrictions to the one or more forms of the recorded personal data files respectively;

the access restriction including a predefined event that is not time defined but defined by one or more conditions or circumstances of the user

wherein an authorised person can access the authorised form of the personal data files of the user upon the occurrence of the predefined event and therefore the user has control of dissemination of the user's personal details when the condition or circumstance of the user at the time warrants such dissemination.

The essential data communication system can have an access record created to record the access of the user's personal details by authorised person and the access record being accessible by the user such that the user has control and information of the dissemination of user's personal details.

The essential data communication system can have an identity means which records an access address of the recorded personal data files and a code such that a person can use the code to access the user's personal data files and thereby assist the user in need while the user still maintains control of the personal data files and access by the predefined access restrictions.

The essential data communication system can also define a form of personal data file and authorise a particular form of broadcast of that personal data file on the instigation of an event predefined by the user. That event can be when a caregiver or authorised person notifies that the user is lost or disorientated.

Throughout this document including the claims the “user” can include the “at risk” person, the user's caregiver or representative who acts in accordance with the wishes of the user. The user can be family or non-family member of at-risk person.

The essential data communication system including broadcast means being operative to allow selective broadcast of a predefined personal data file when a condition is fulfilled. The condition can include overriding user-defined conditions and any other required conditions after which selective broadcast is to be allowed. In this way the user has the option to keep disappearances or medical events to be kept low key and out of public scrutiny such as by only having Doctors have access or define general police broadcast or internal communication of Police network. In this way the user maintains control and dignity and controls how others use the personal data even when user is at the time of use, disorientated or lost or medically handicapped.

The condition can include an authorisation of any editing of the information on behalf of the user. The condition can include a geographical limitation of the broadcast or the locations from which authorised access is allowable.

A computer program product for use in essential data communication system with input means by a user enabling the user to record personal data and to provide an access restriction associated with said recorded personal data which limits access to authorised person and user defined event definition that is not time defined but defined by one or more conditions or circumstances of the user wherein an authorised person can access the authorised form of the personal data files of the user upon the occurrence of the predefined event and therefore the user has control of dissemination of the user's personal details when the condition or circumstance of the user at the time warrants such dissemination.

The computer program product for use in essential data communication system with connection to as predefined communications network with the program providing an defined form of personal data file and authorise a particular form of broadcast of that personal data file on the instigation of an event predefined by the user. That event can be when a caregiver or authorised person notifies that the user is lost or disorientated.

Depending upon the embodiment of the invention, the system may include one or more of the following features:
SRH/ID Assist connects end users directly with their online record—they can create, add and modify directly with their private access. They can also view if the record has been accessed.
The missing person report in ID Assist can be generated by the consumer—not just the emergency service.
SRH/ID Assist connects end user directly with emergency services via a shared electronic record—the aspects of the record that are made available are determined by the end user.
Alerts can be sent electronically by the system if indicated by a carer to emergency services directly—this viewing of this ‘alert’ can be then verified back to the end user.
For SRH/ID Assist the end user can post the missing person report to the website directly to elicit public help.

### BRIEF DESCRIPTION OF DRAWINGS

The invention also provides other systems and apparatuses that are apparent by person skilled in the art as shown by way of illustration only with reference to the drawings and examples wherein:

FIGS. 1a to 6k are copies of website pages showing working of identification assist system and medical assistance system forms of the essential data communication system of the invention in the applicant's “Safe Return Home”™ form of the essential data communication system including:

FIG. 1a Administration Section

FIG. 1b Organisations access levels

FIG. 2 Users access levels

FIG. 3 System registration

FIG. 4a System Search Area parameter enquiry

FIG. 4b System Search Area search results to parameter enquiry

FIG. 5 Missing People public website display

FIG. 6a System Information—personal details and personal details (expanded)

FIG. 6b System Information—medical details and medical details (expanded)

FIG. 6c System Information—behavioural & diagnosis details and behavioural & diagnosis details (expanded)

FIG. 6d System Information—health professional contacts

FIG. 6e System Information—personal contacts and photo admin (completed online)

FIG. 6f System Information—Missing episode report area

FIG. 6g System Information—Missing episode report area (expanded)

FIG. 6h System Information—Alert Area

FIG. 6i System Information—System access audit area by user

FIG. 6j System Information—User defined permission areas

FIG. 6k System Information—Help Area

FIG. 7 is a flow diagram of the software system for the safe return form of the essential data communication system;

FIG. 8 is an internet site map that can be used for an identification assist system form of the essential data communication system of the invention;

FIG. 9 is a diagrammatic view of the identification assist system of the essential data communication system using internet access option;

FIG. 10 is a diagrammatic view of the identification assist system form of the essential data communication system showing extract file to police system option;

FIG. 11 is a diagrammatic view of the identification assist and medical assist forms of the essential data communication system;

FIG. 12 is an entity relationship diagram of the database for use in the identification assist system form of the essential data communication system;

FIG. 13 is a diagrammatic view of an identification card for the identification assist system form of the essential data communication system;

FIG. 14 is a diagrammatic view of identification card for the medical assist system form of the essential data communication system;

FIG. 15 is a tabular view of the recorded essential data of the medical assist system form of the essential data communication system;

FIG. 16 is a tabular view of the recorded medical essential data of the medical assist system form of the essential data communication system for recording changes and evaluation of essential data;

FIG. 17 is a more detailed tabular view of the recorded medical essential data of the medical assist system form of the essential data communication system for recording changes and evaluation of essential data;

FIGS. 18a to 26 are copies of website pages showing working of medical assist system and medical assistance system forms of the essential data communication system of the invention in the applicant's “Medi Assist”™ form of the essential data communication system including:

FIG. 18a entry window

FIG. 18b Administration main menu

FIG. 18c Record Search

FIG. 19a Personal Details—Registrant details

FIG. 19b Personal Details—Identifying details

FIG. 19c Personal Details—Language Proficiency

FIG. 19d Personal Details—Sensory Impairments

FIG. 20a Personal Contacts

FIG. 20b Record creator

FIG. 21 Health Contacts

FIG. 22a Health Reference—information

FIG. 22b General Medical History

FIG. 22c Health notes

FIG. 22d immunisations

FIG. 23a health care plans—medical conditions

FIG. 23b health care plans—medications

FIG. 24 measurements and monitoring a) pre-diabetes, b) diabetes c)asthma d) cardio-vascular e) weight management f) blood test g) psychological h) physical

FIG. 25 broadcast form of essential data

FIG. 26 user defined access to essential data.

FIGS. 27-41 depict alternate embodiments of the subject matter of FIGS. 1a to 6K. The drawings may be interchangeable or may describe separate but related embodiments.

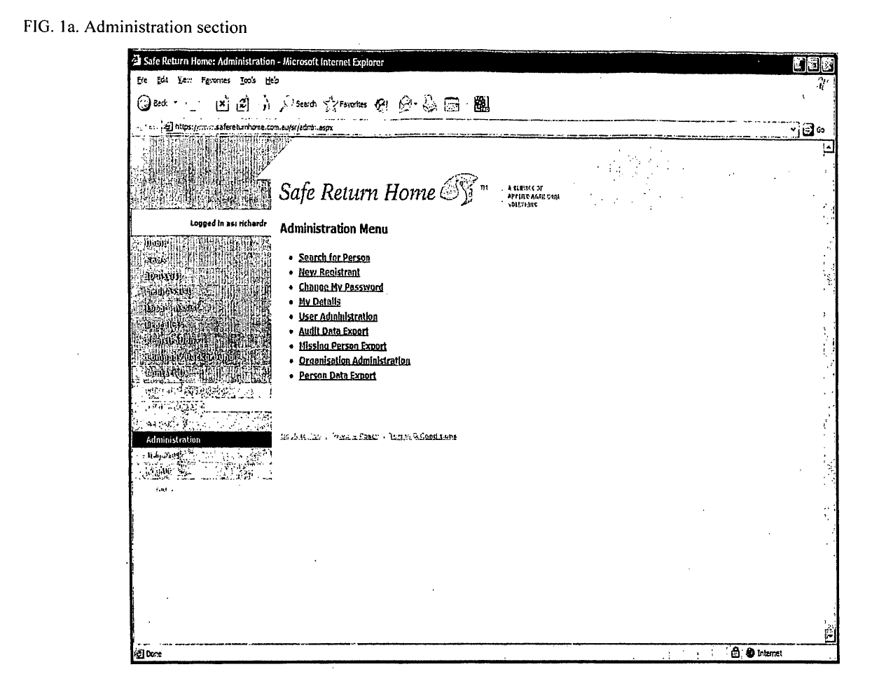

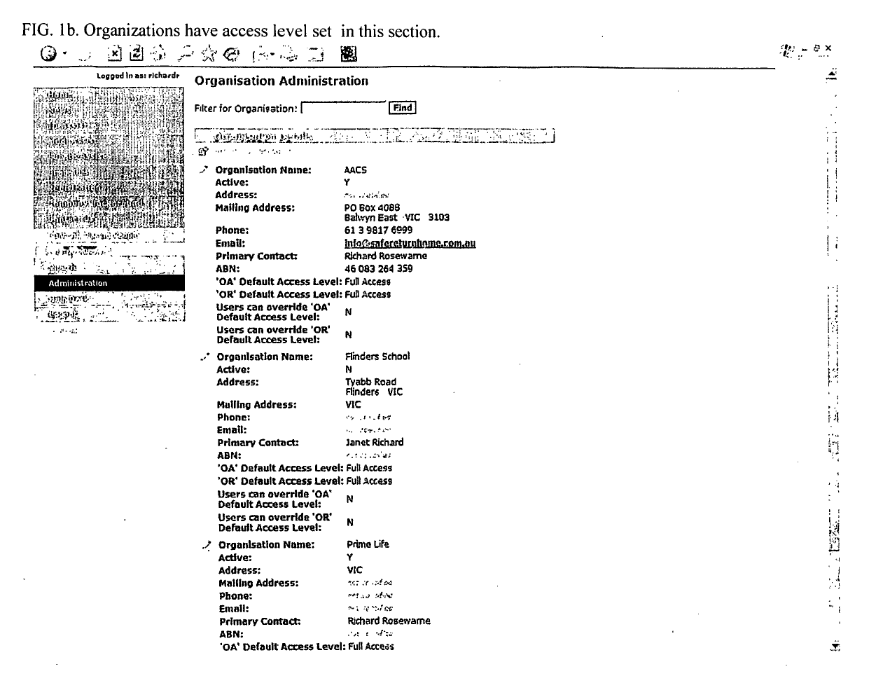

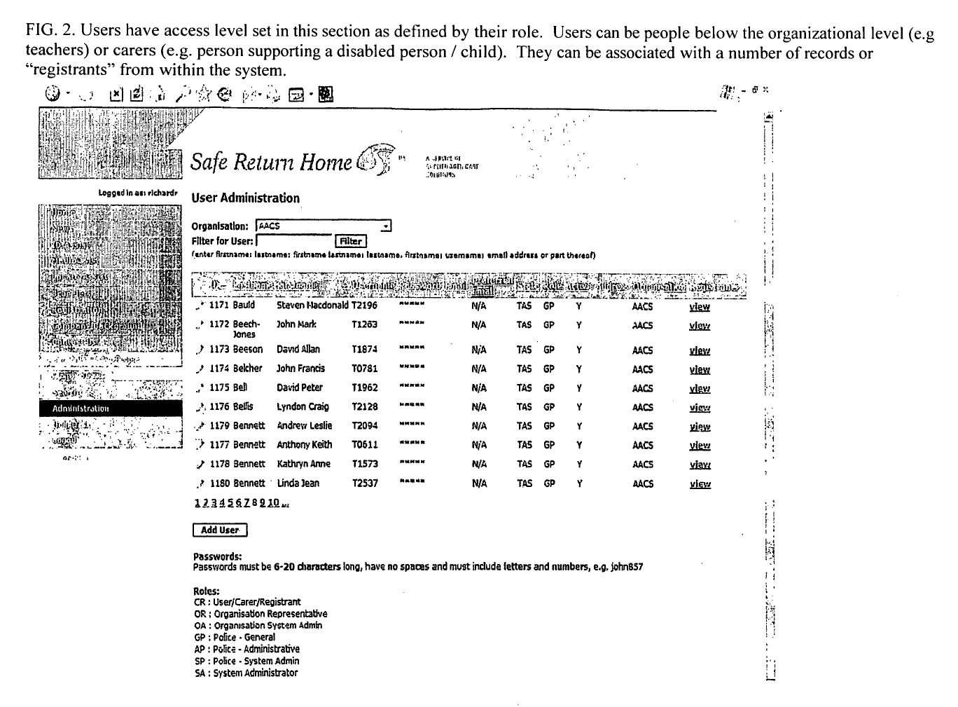

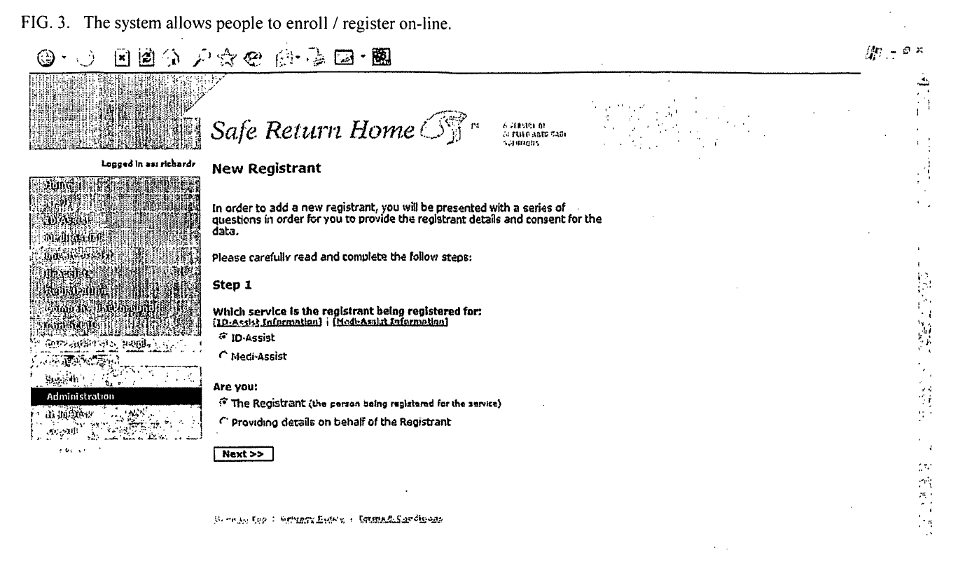

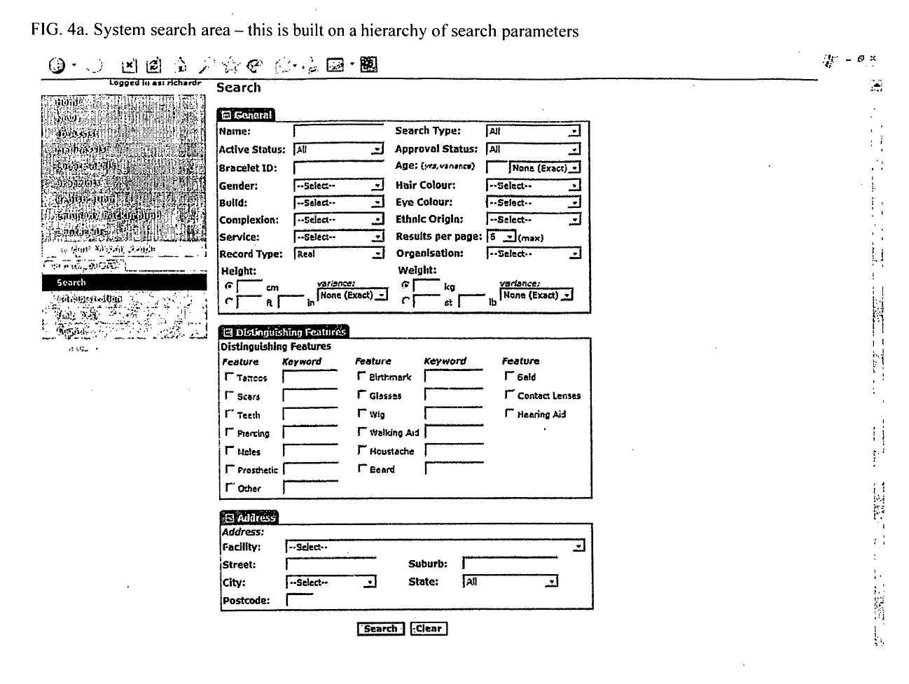

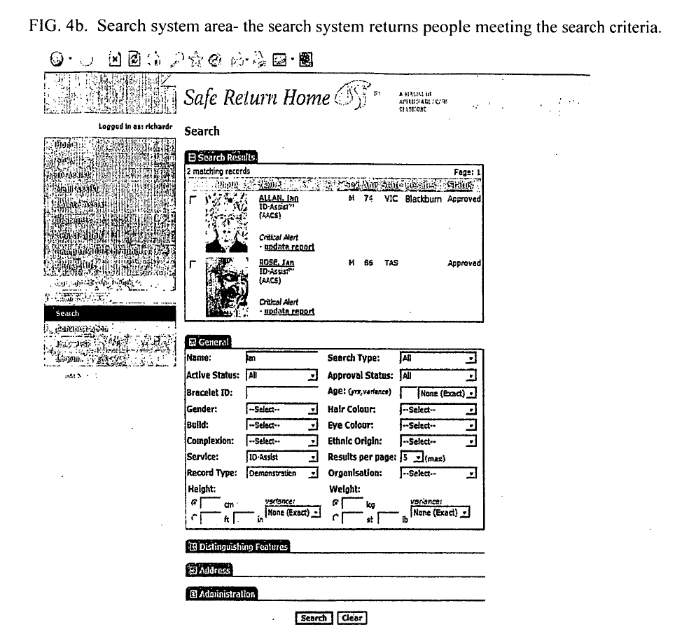

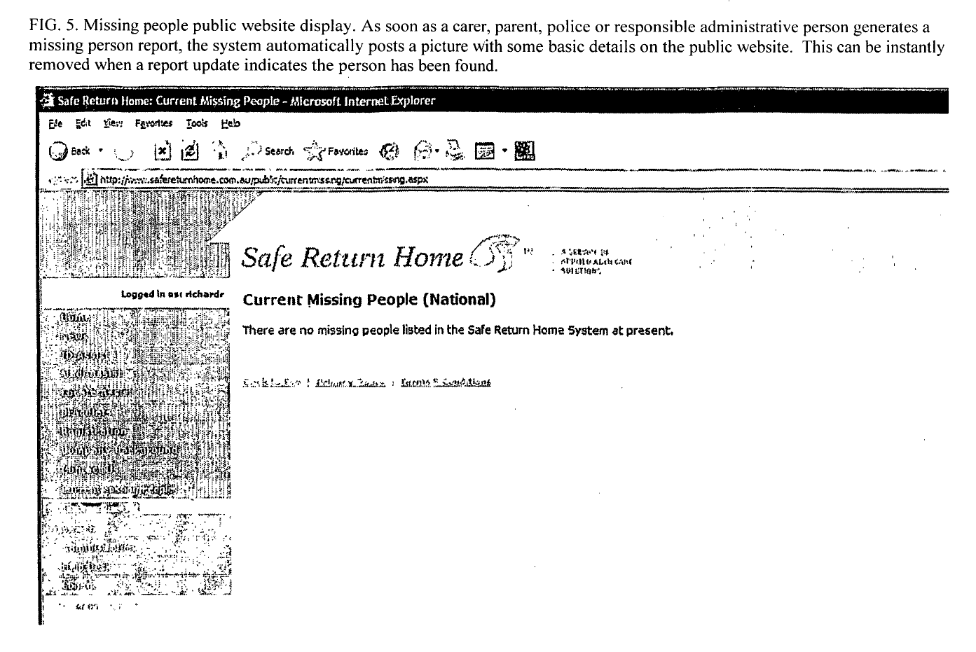

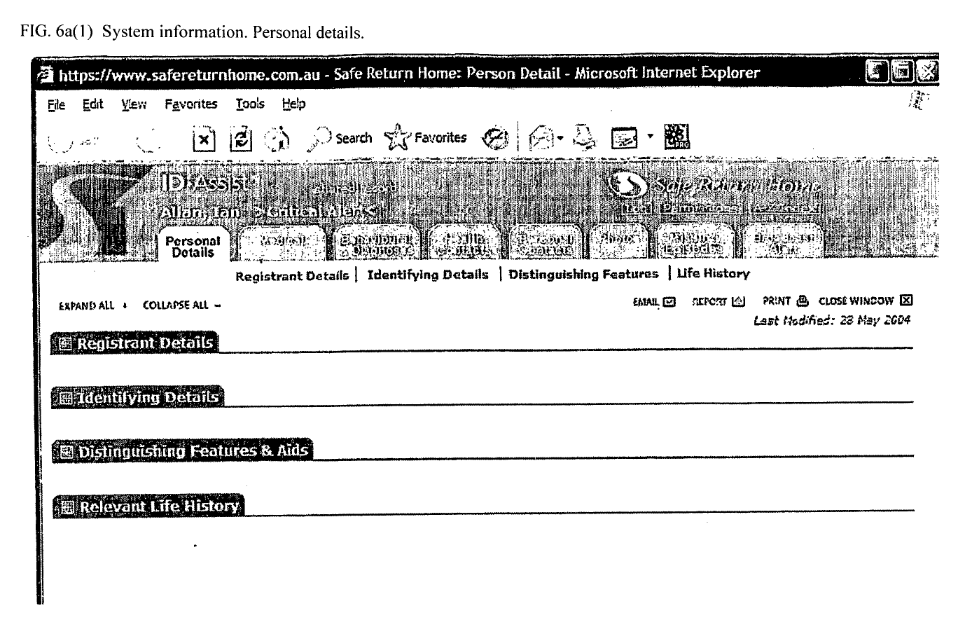

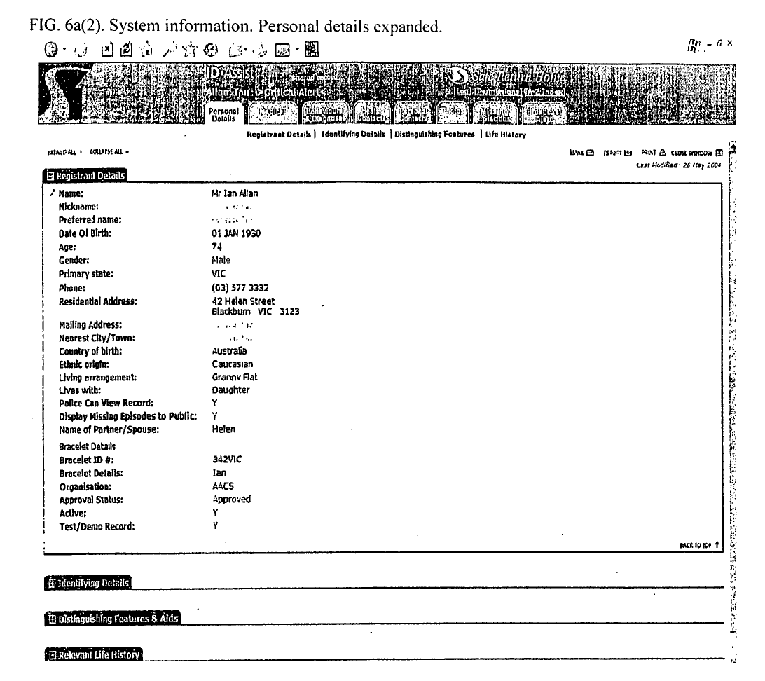

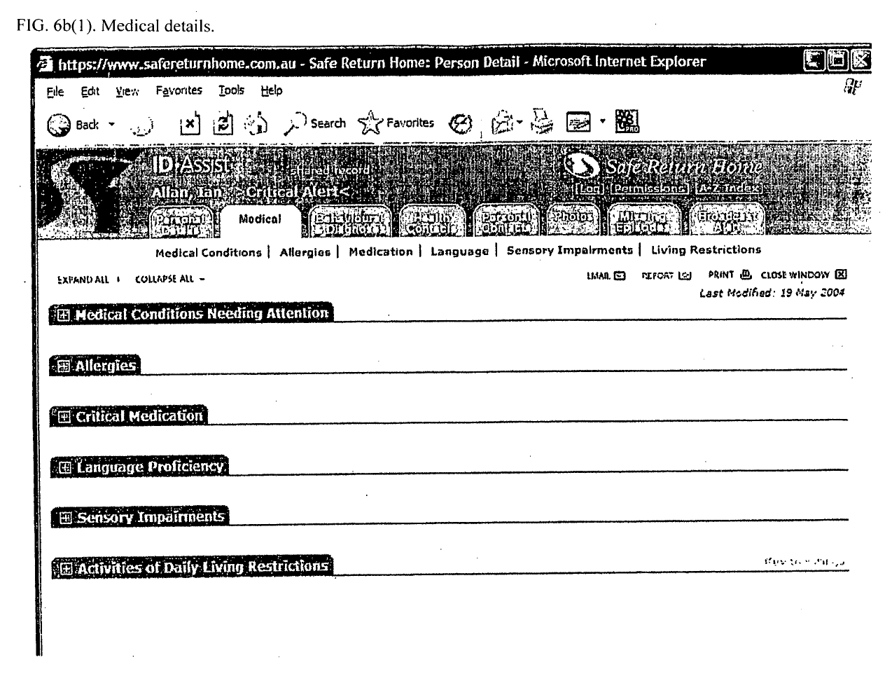

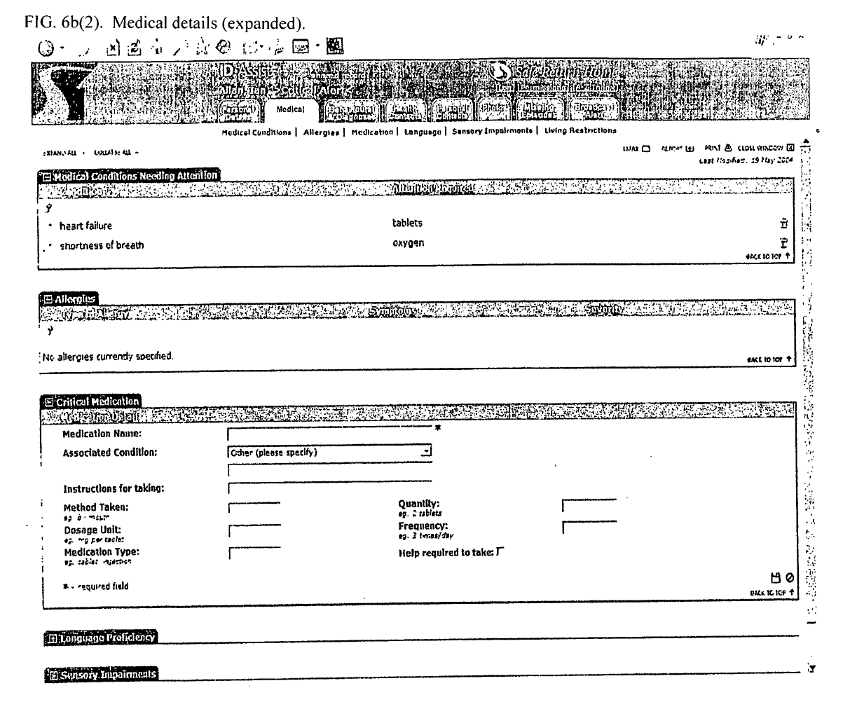

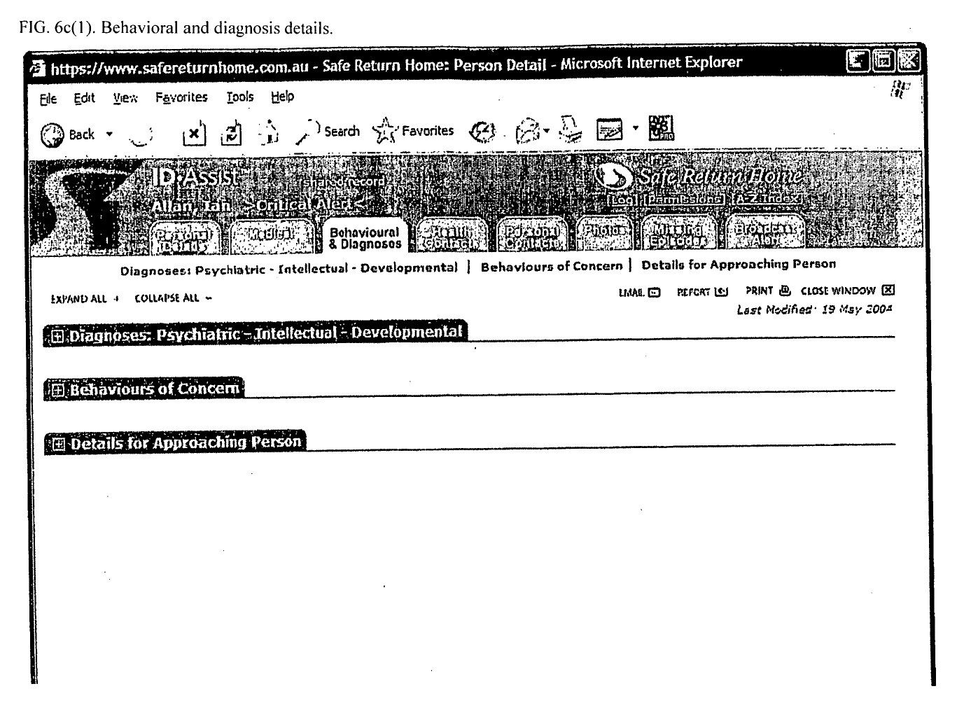

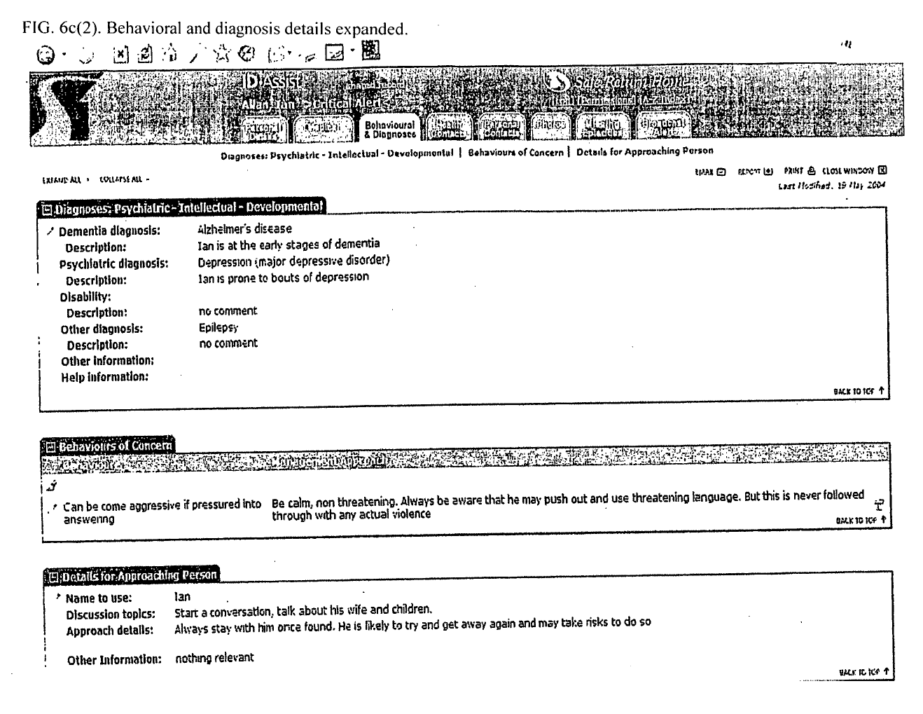

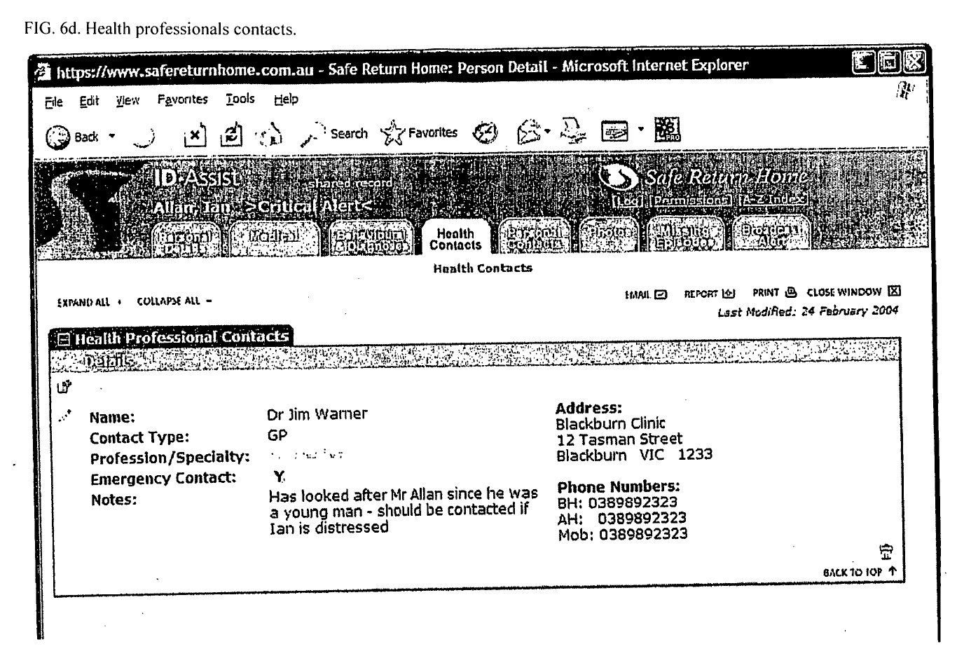

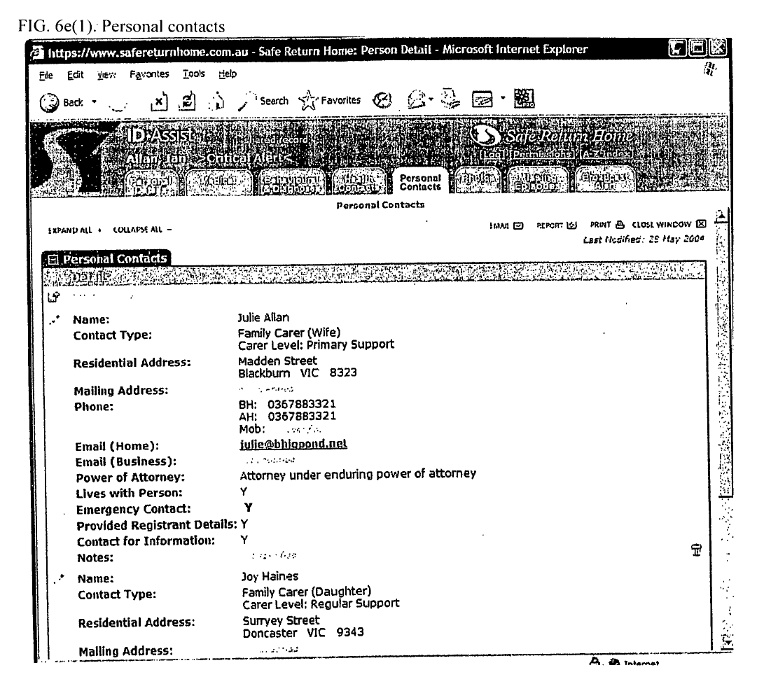

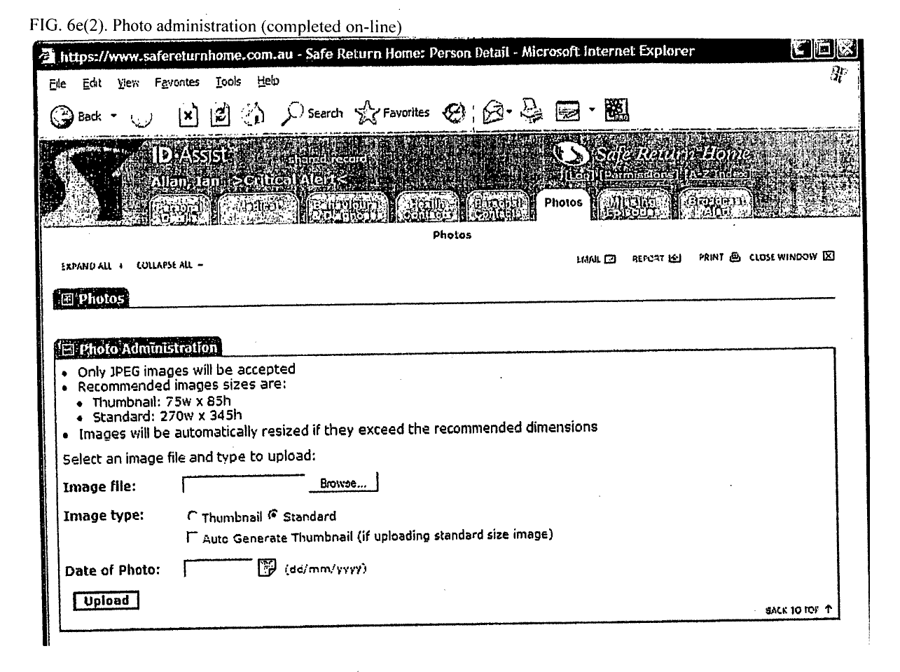

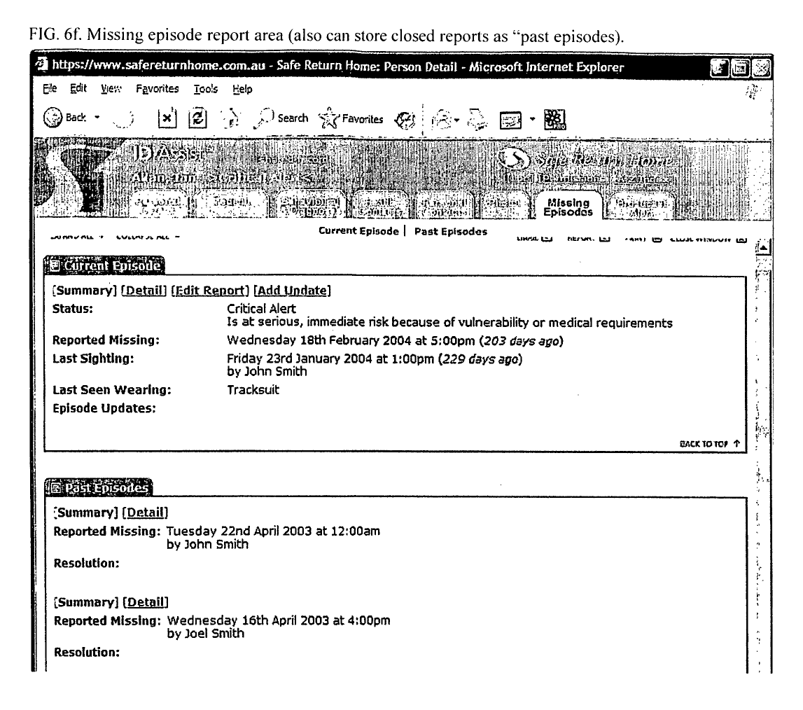

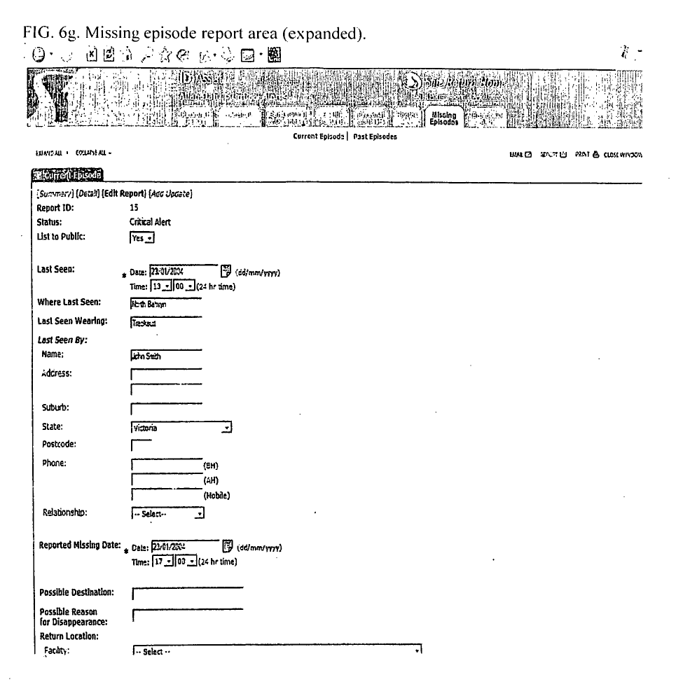

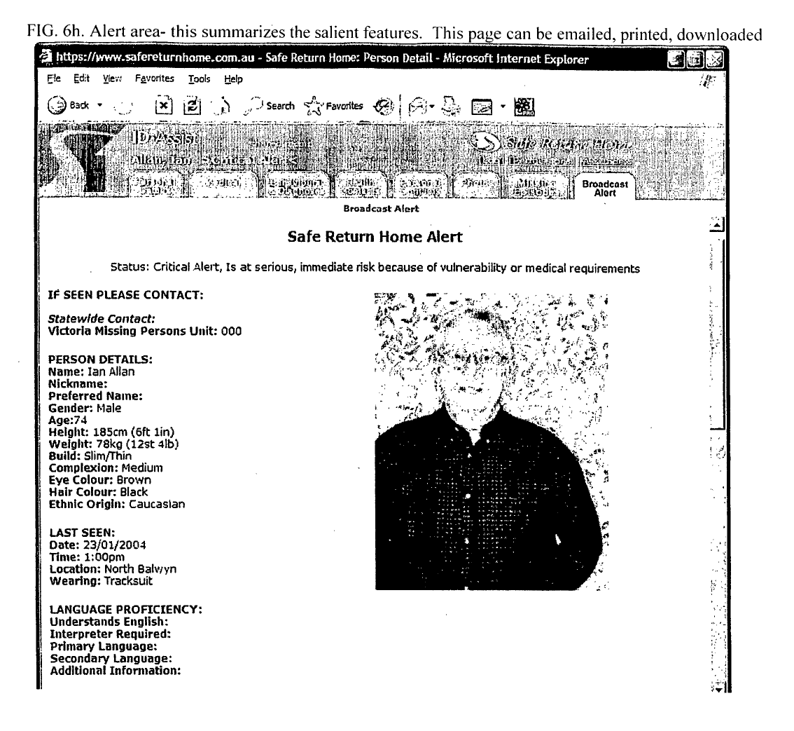

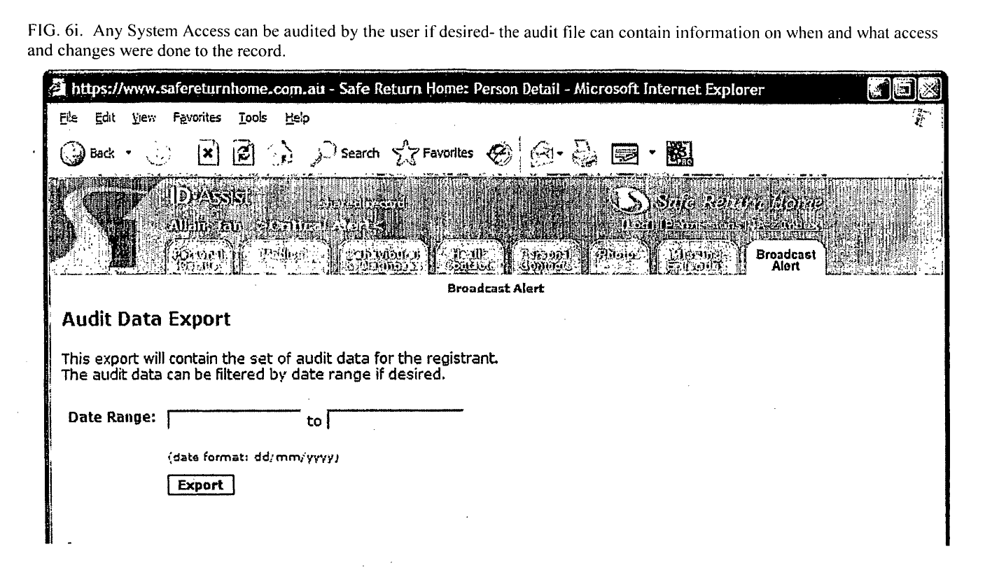

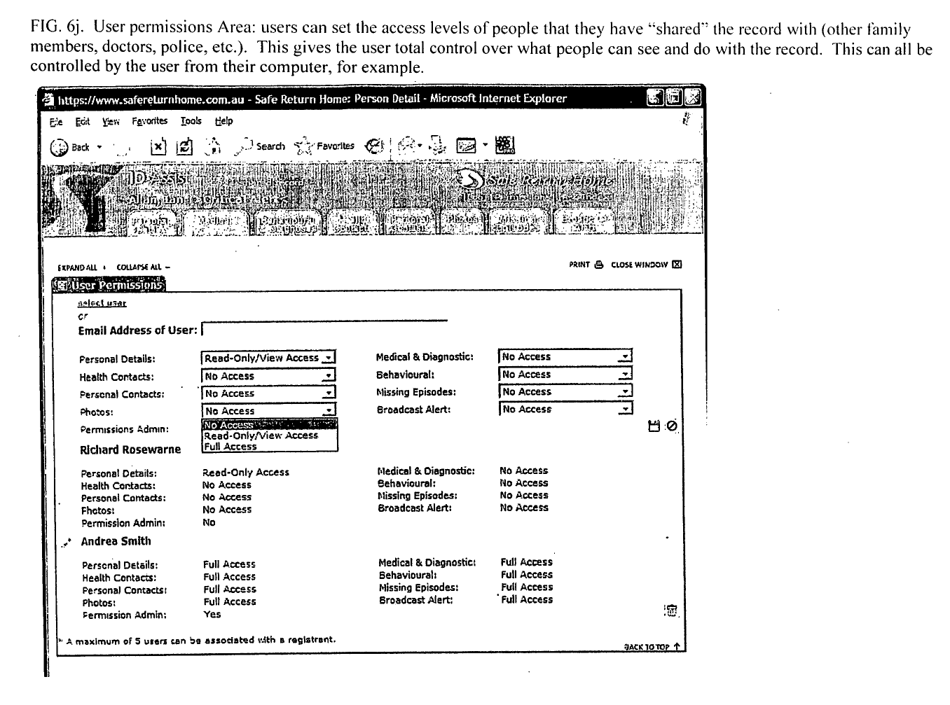

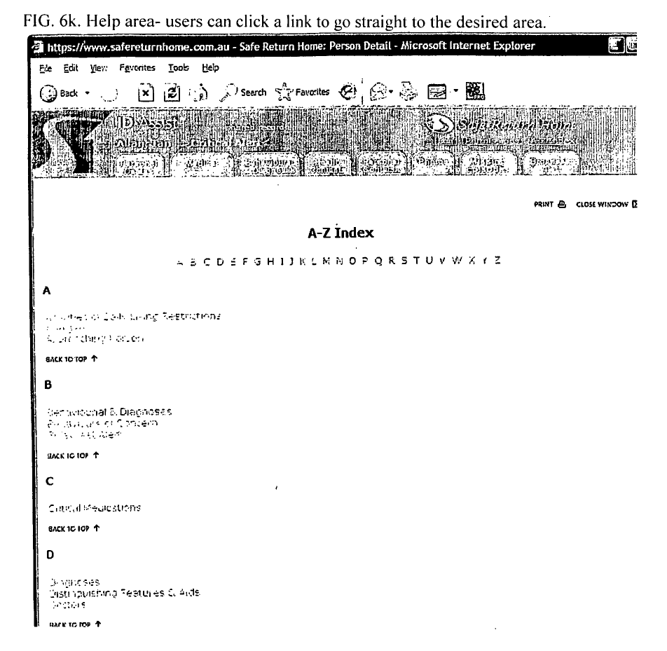

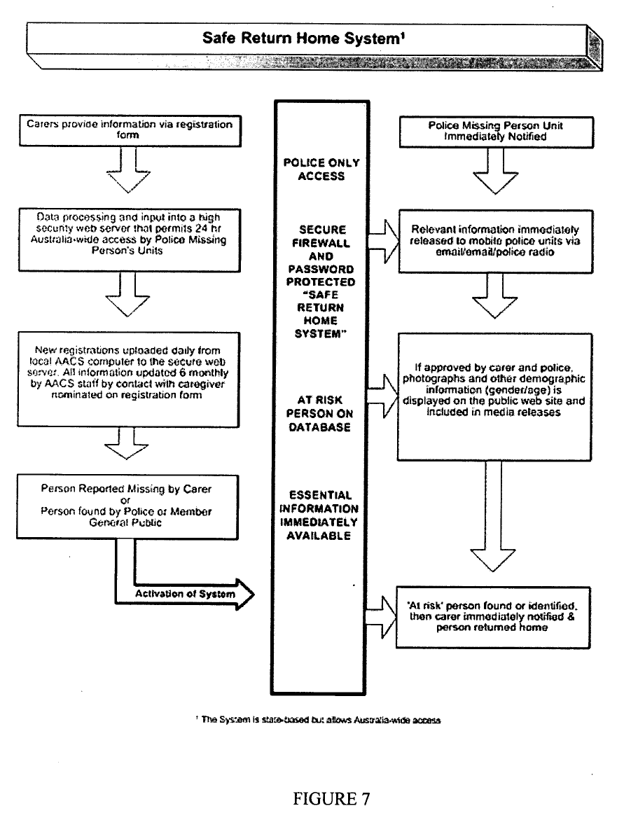

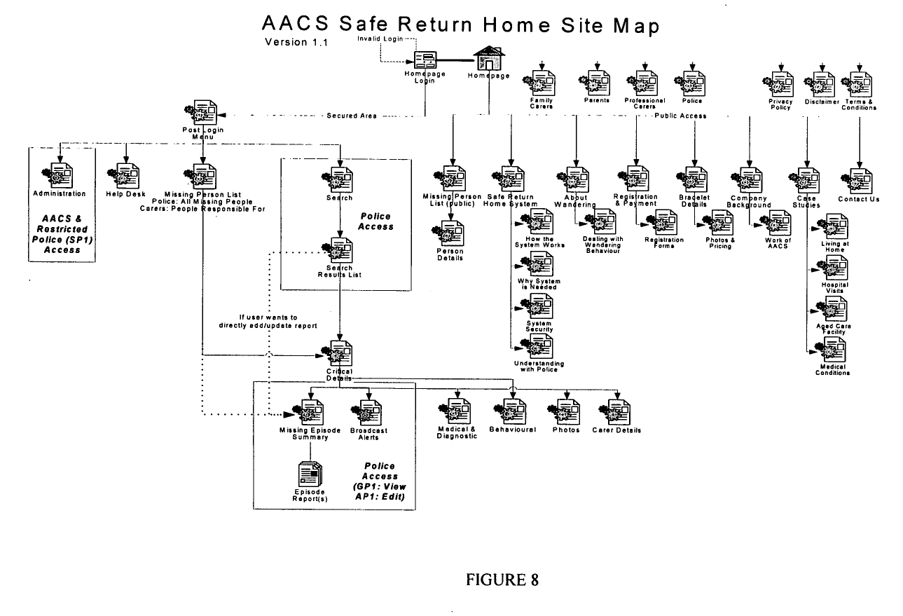

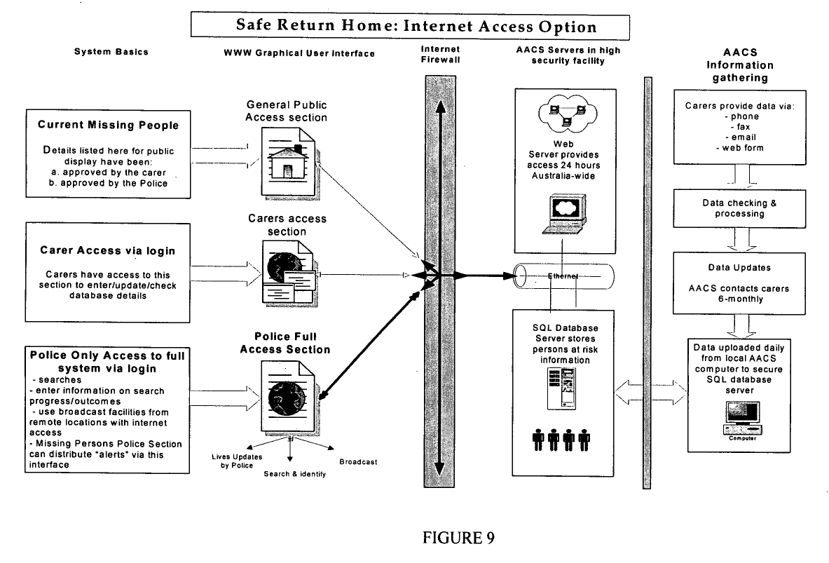

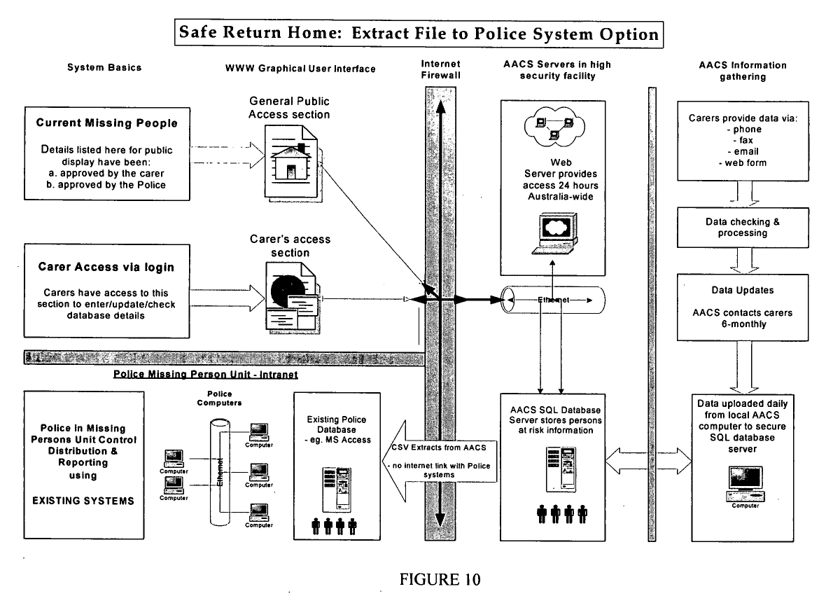

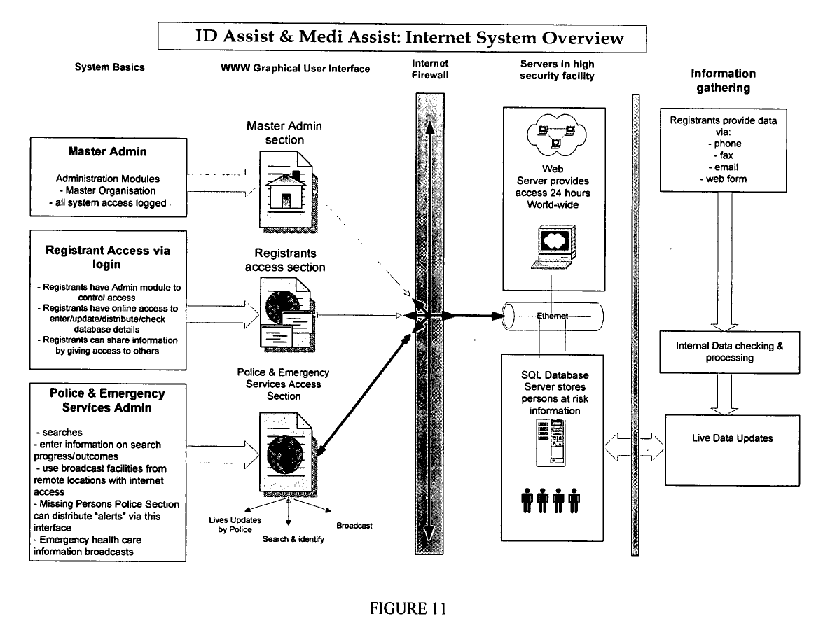

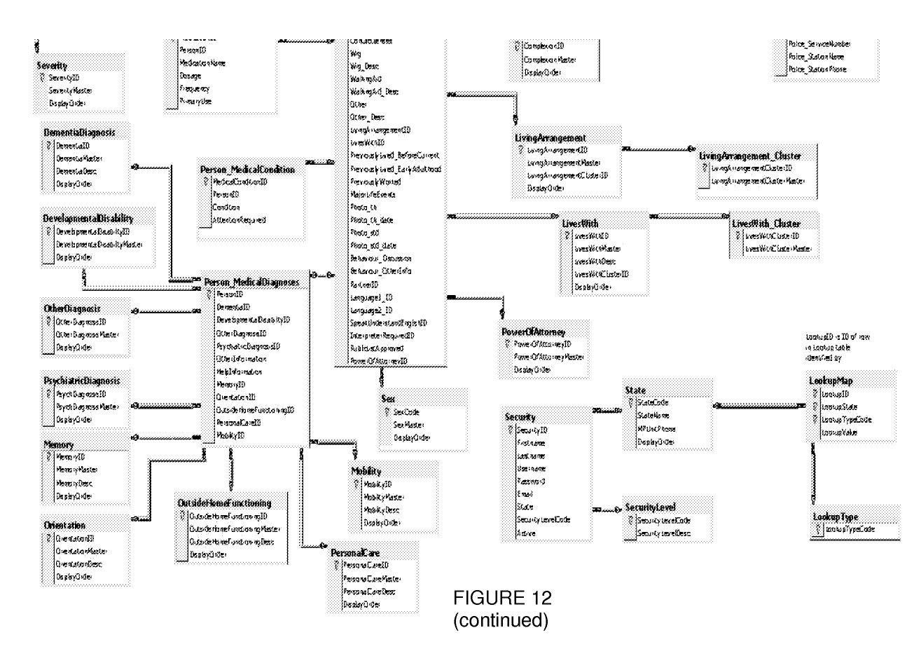

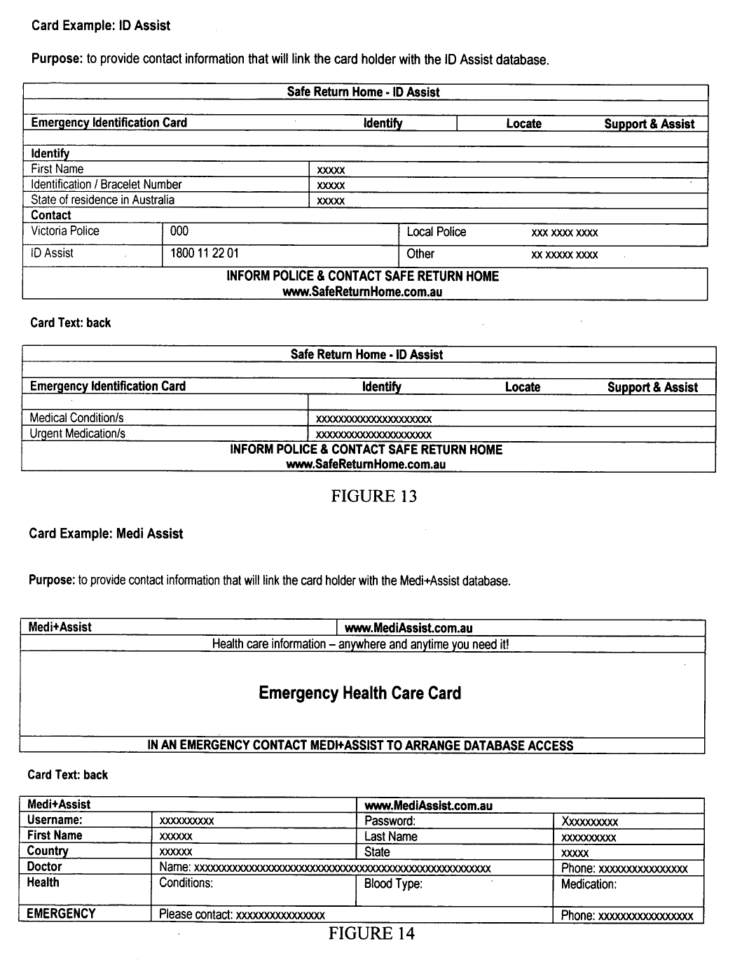

### DESCRIPTION OF EMBODIMENTS OF THE INVENTION

Underpinning the identification assist system form of the essential data communication system is a sophisticated web-based software system that has been developed by the applicant with a long term commitment to the support of people with dementia and their caregivers via clinical, applied research evaluation and now information technology solutions. The identification assist system of the essential data communication system enables the storage of vital information necessary in an emergency situation, including identification details, high resolution photographs, as well as medical and behavioural information. This information is controlled by the registered user/their authorised representative(s) and can only be accessed by the Police or those with approval. It has been built to operate across all Police jurisdictions thereby providing nation-wide coverage for ‘at risk’ people.

### EXAMPLE

### Identification System

The applicant's identification system known as “ID Assist™” is for any person considered ‘at risk’. This is someone that might become disoriented and go missing or otherwise need assistance from police/emergency services. As such the system applies to not only older people with memory loss but also others with intellectual disability, developmental delay, mental illness, physical disability or a brain injury of some type (eg. closed head injury).

The system is for people at risk of becoming lost so that if the user have a loved one or support people of any age with orientation and memory problems or psychological needs, then the system is designed to assist the user. The identification assist system consists of an internet database to store relevant details to help with the location and identification of a person who is at risk of wandering (for example a person with Alzheimer's disease or dementia). The user can also purchase a high quality bracelet for on-person identification. There will be no panic or rush to organise important details needed by Police in case of an Emergency.

The system works by a secure and confidential national data system that contains the relevant details necessary to assist police in finding or identifying an ‘at risk person’. The system is available for Police 24 hours, every day from any location in Australia.

The caregivers provide all information, including demographic details and any relevant medical or behavioural information that may assist in the locating or identification of the person concerned. A high-resolution photograph (suitable for mass distribution in a range of mediums) is also included. Caregivers control what information is supplied and how it is used. The system operates as follows:
People can be added onto the system via a completion of a mailed application form or via an online registration system.
A recent colour photo is required that allows a full length and face image (the image must be high quality and allow for magnification).
The information on registrants also includes the history of any relevant behaviour and previous incidents (dates/times), including where the person was located.
Optionally, the system provides information regarding the person's medical practitioner, critical health conditions and medications, level of memory and disorientation, independent living skills capabilities, any behaviors of concern and suggested management approaches.
Registration details (photo, demographics, previous episodes and contact information) are be updated every 6 months via contact with the caregiver.
The registration is under the control of caregivers—they provide the information they want and can edit this via the private area of the public web site. Caregivers have access to their relative's details only.

Therefore the identification assist system allows the user to deliver an immediate response to Police in the case of an emergency. Once Police are informed of a missing person episode (via phone or email directly from the web site) they can search the database and broadcast all the relevant data on the missing individual, including photo ID to the relevant Police Units and other community services (taxi, bus and train companies; shopping centres etc).

Registered users can enter and edit all data online. They can also print and deliver relevant information, or email to the local Police station or Missing persons sections directly from the system. Registered users are in complete control of the information and how it is distributed.

The system has been designed to attempt to:
provide an effective statewide system with national application.
provide an easy to use ‘state of the art’ system for families, caregivers and people ‘at risk’.
ensure that appropriate privacy standards are met and maintained.
allow all information collected to remain under the control of caregivers.
ensure accountability to all concerned parties (caregivers, Alzheimer's Australia, Caregivers Australia, other peak bodies representing caregivers, and people with dementia).
encourage Police in all districts to explore the relevance of dementia support services.
lift the profile of dementia care issues within the community.
Some typical scenarios are as follows:

1. Person is reported missing by caregiver.
Police have immediate access to the information required to initiate a search and an alert can be immediately issued to Police Stations
If the caregiver approves, photographs and other demographic information (eg: gender and age) can be made available to the media and general public, via the website or press-releases
Once the person is found the information provided on the identification assist system can assist Police in knowing how to approach the person in a way that will not cause them any unnecessary distress
The information will help Police to know whether immediate medical assistance is required
The caregiver will be immediately notified and the person returned home

2. If a disorientated person is found by Police or member of general public
Police can immediately search the systems database to access information to determine the identity of the person.
Caregiver contacted as soon as a positive identification is made.
Again, the information provided on the identification assist system will enable Police to reassure the person and minimise their distress. It will also assist Police in determining whether immediate medical assistance is required.

It can therefore be seen that the system is needed for peace of mind and safety.

The identification assist system can be used by the Police to help them identify and locate missing people with memory loss, confusion and/or disorientation.

In the event of a missing person episode, identification details are immediately available for Police via the Internet. The system allows Police to search, and broadcast identifying information. Families and caregivers will not be faced with the panic of having to organise these details for Police at the time of an incident.

The system provides many features including:
an up-to-date secure internet system that is available for Police, families and caregivers 24 hours a day
Police can immediately broadcast details on the missing person (eg. high resolution photograph) locally or statewide
a public web site enabling people in the community (eg. public transport, taxi and shopping centre management) to check details of missing people
families, caregivers and registrants have their own private access area on the system. They can check the details of the registrant (or self) online using their unique username/password that they can change at any time
families, caregivers and registrants can also store essential descriptive (eg. doctors contact details) and medical information (eg. medications, allergies) for reference if desired. Strict privacy and consent conditions apply.
the option of purchasing a high quality ID bracelet with specialised engraving from the system provider for additional security.
Affordable fees for 24-hour access, a personal web storage and information retrieval area and 6-monthly updates

The system is controlled by a secure password system whereby all users have a loxin and password assigned to them. The login and passwords are unique for each person and they are required to be kept confidential. The database site is encrypted by using 128-bit SSL encryption technology to protect usernames and passwords and to encrypt access to sensitive information on the website. 128-bit SSL is the same encryption used by commercial banks and is sometimes referred to as “military strength”. The 128 bit SSL ensures that all data, including usernames and passwords, are encrypted during transit from the user's browser to the website, and that pages containing sensitive information are not “cached” on computers (i.e. stored temporarily on computers via cookies). SSL encryption is also used for any uploading or downloading of data directly to the database.

The database has audit functionality so that a complete history of changes to information is tracked by person (login) and time of access. The system will also track who is accessing the database.

The server is stored in secure and monitored facilities. Firewall and server configuration adheres to and will follow security guidelines and industry best practices. Vendor released security patches are applied regularly.

Mobile Phone

The identification assist system can also include the very latest GPS-GSM mobile phone technology for monitoring assistance and emergency location tracking outside of the home. In areas with mobile phone coverage, a person with the special GPS mobile phone can be located to within 20 metres using satellite technology. This service will in future link with the services to provide a comprehensive monitoring, location and emergency service. If a person triggers an alarm on the phone, the monitoring service will be able to not only locate the person to within 20 metres anywhere in Australia (with mobile phone coverage), but have instant access to vital information on the persons health status medical and family contacts stored in the identification assist system internet systems (if registrants approve this access in an emergency). The phone allows two-way discussion over the external speaker should an emergency worker require further information on the medical assistance system or identification assist system.

The mobile phone used for this system can be a combination of a fully-featured dual band GSM mobile phone and a high performance GPS receiver.

Card

1. Emergency Card: Both the identification and the medical forms of the essential data communication systems have the capacity to print off an “Emergency Card”. The card is double sided and will be made available in PDF format from the respective web applications, and populated dynamically with key user information—users will be able to select online what information they want for the card. The cards can then be printed from a home printer and folded for use as a wallet reference card.

2. Emergency Access to Special Website areas: The Emergency Cards will also have a printed link and individualised username/password to the relevant website so in the event of an emergency—more detailed patient information can be accessed online (in the ID form: Broadcast Alert; Medi-Assist: Emergency Summary). This link gives non-registered users or emergency services/medical personnel access to selected emergency information on the relevant website—this information is determined and controlled by the user/registrant. Further, the registered user has the ability to control the actual password for emergency summary/broadcast alert and can change this as required.

Internet

For those registered on the identification assist system of the essential data communication system, a missing person report can be made by phone, or an ‘alert’ can be posted to Police from the caregiver's (or an aged care facility) secure internet access area. The system provides Police with immediate access to information online from any location and the ability to quickly distribute this information to other Police units or locations. The system also allows the Police to send update reports to the caregiver during a missing person episode.

The integration of the identification assist system form of the essential data communication system using internet technology to link the Police and caregivers is unique in Australia and the world and provides distinctive benefits to all concerned.

The benefits of the identification assist system form of the essential data communication system to caregivers and ‘at risk’ individuals include a secure ‘state of the art’ software system, which allows minimisation of panic and time needed to initiate procedures in an emergency. However privacy of the registered user/their authorised representative is maintained by control of the information stored on the system. Confidentiality of the system is maintained by username and password protection with only the Police and individuals authorised by the registered user/their representative able to access the information. Overall the system provides the opportunity to lift the profile of dementia care issues within the community and maintain self-respect.

The benefits to the Police include a high quality system with easy access to up-to-date information. It provides an efficient use of Police resources. Further the use of web base of the system provides remote access providing a statewide or national service. This allows the ability to track users of the system by username and IP address.

The safe return form of the essential data communication system on a software system could be easily adapted for use in other countries and may have direct relevance to future development of a national ‘safe return form of the essential data communication system’ system to operate in various countries including in the USA.

### EXAMPLE

### Alzheimer's Associations

This system can provide the Alzheimer's Association with a new approach to the wave in which it sets-up the ‘safe return form of the essential data communication system’ program: one that is more flexible, progressive and consumer focused.

Furthermore, it will open up the ‘safe return form of the essential data communication system’ concept to a much broader group of users and at an organisational level, while keeping the cost structures for administration low both now and into the future.

The software has been developed with a sophisticated Administration structure to enable an agency, such as National Alzheimer's Association, to manage the system nationally and give local administration to the chapters in the various states if desired.

In the Alzheimer's Association system—Master Administrator the master administrator is in control of the entire system. This level can be operated in a number of ways:

a. Users set-up directly via web-based data entry (if users submit forms)

b. Other organisations (eg. Chapters) can be set-up to administer groups of registered users. In this case the Chapters would manage their own local/state-based areas on the database directly from their web-based interface if they so choose.

c. Other classes of users could also act as an administrator for their clients. For example if a respite service or residential service provider (or organisation) wanted to join the system, the Master Administrator (Alzheimer's Association) can set these organisations up on the system to enter their own group of registered users.

The Master Administrator has a report module linked into the system that provides reports on billing, number of registered users, organisations and a master log that records access to all parts of the system via IP logging and activity mapping.

The system has a special Police administration section, that enables Police to set-up and administer all Police users (this can be done by local area/region/state), fill in missing person reports online and broadcast a summary page on the missing person (including photo).

Police have three levels of access—system administrator, administrator, and general Police. This gives Police control of their section and enables them to be effective through direct access to registered user details (via their intranet or the internet). The system puts caregivers directly in touch with Police at a local, regional, or national level.

Finally, the safe return form of the essential data communication system provides caregivers with significant value in addition to that provided by traditional ‘safe return form of the essential data communication system’ models. Registered users can give access to their record in an emergency, to the emergency personnel such as police, medical, hospital, ambulance or other health professionals from their administration module. A more detailed discussion of the safe return form of the essential data communication system follows.

There are many major benefits to users including caregivers and people with dementia (registered users) which are at the centre of a preferred method of the invention. The system is ‘consumer’ focused, as it fits with the developing view of consumers who wish to be in control of their private information.

Registered users can either complete registration forms or set themselves up directly via the internet. Once registered, access is via a username and password. Registered users can then enter information, and keep this updated via the web. They can distribute their information via email, download, and print or fax their information as required. They can even give family members access to add additional details or add important notes.

Registered users can use their information for other health related needs. The information on health care needs provides an important “health record” for caregivers, family members and services such as doctors, hospitals, respite, day centre, assisted living and retirement village environments. It is also extremely useful should people travel and be away from their usual place of residents and have an emergency health care need. The health information stored on the system can be downloaded, emailed or printed off as required and means caregivers will get significant value from participating in this version of safe return form of the essential data communication system, even if they don't ever need it for a missing person episode.

The health care information stored on the safe return form of the essential data communication system includes sensory impairments (vision, hearing, speech), memory, orientation, personal care, walking & agility, transport use & access, medical contacts, medical conditions & attention requirements (unlimited), important medications (name, associated medical condition, dosage, unit, times/day, route), diagnostic information (dementia, developmental, psychiatric), and behavioural information & suggested management approaches. If clients wish they can have a complete health record system.

Registered users can also give access to their record in an emergency, to emergency personnel such as police, medical, hospital, ambulance or other health professionals from their administration module. This may prove lifesaving in medical emergencies. The sophisticated registered user administration module means registered users/their authorised representatives' control who view their information and how it is distributed.

Registered users/their authorised representatives (eg. aged care facilities) can post missings person episodes directly from the software—the software provides a format for completing a report and email contacts for local Police, state or national authorities. Police users can communicate directly back to the person posting the alert via email to inform them about the search—the system gives a ‘trace’ back to caregivers to let them know Police have accessed their email communication.

Looking at specific embodiments of the invention there is provided an identification assist system and a medical assistance system.

The identification assist system works by ensuring police have immediate access to information to assist with missing person search and identification efforts. The system also contains vital medical information on the ‘at risk’ person. It can run in partnership with the Police via direct police intranet at every station, the 000 Emergency Services and via police car mobile data terminals.

The medical assistance system of the invention provides a safe and secure interactive way to store and convey information about medical conditions, allergies, medications, health management plans, immunisations, and medical contacts. It also provides for self-management of conditions by users entering basic health and other medical results and plotting this information over time to monitor changes and improvements. Stylish, high quality medical bracelets and the like are also available for use in the system to physically identify registrants. The medical bracelet pack includes a wallet card that can be used to list important medical conditions and contact information.

### EXAMPLE

### Essential Data Self Management

Registrants can enter medical management plans, detailed medication lists and information on medical conditions in our specially developed forms. This information is stored in the users own private online database area and is totally confidential. The type of information than can be stored include:
1. Medical Conditions: Symptoms, Severity, Special requirements, Treatment plan, history, when first diagnosed, who diagnosed, relevant family medical history.
2. Medications: Current & past medications, medication name, quantity, dosage, frequency, date started & finished.

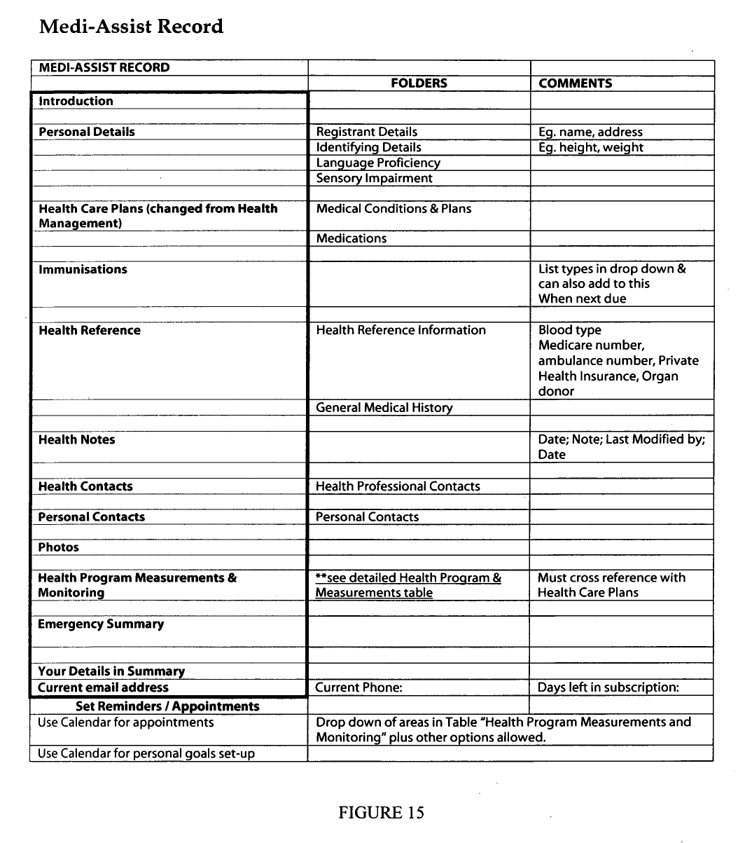

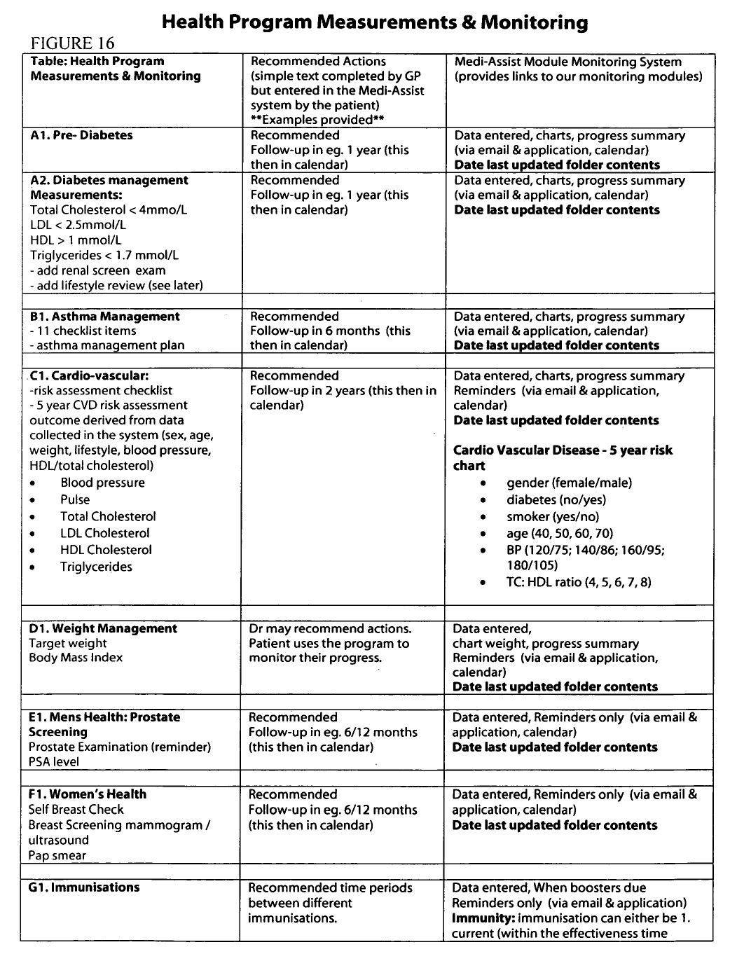

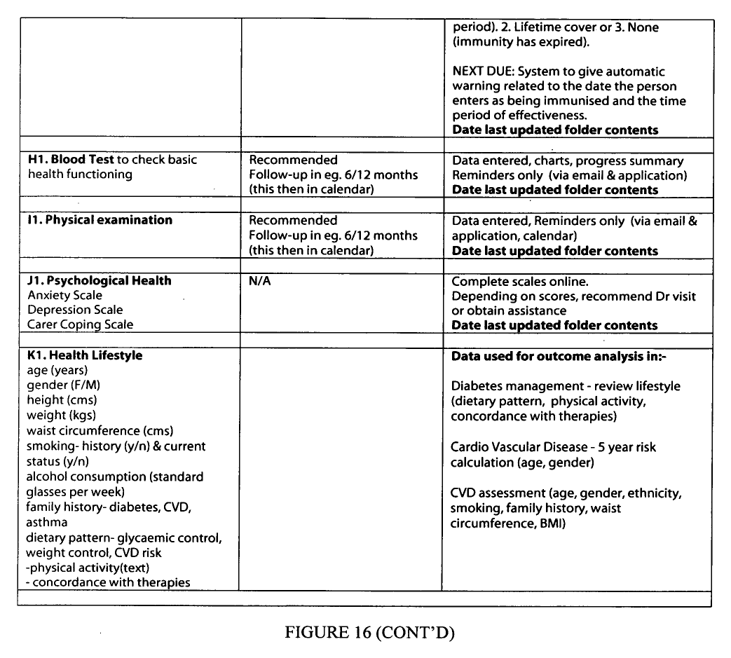

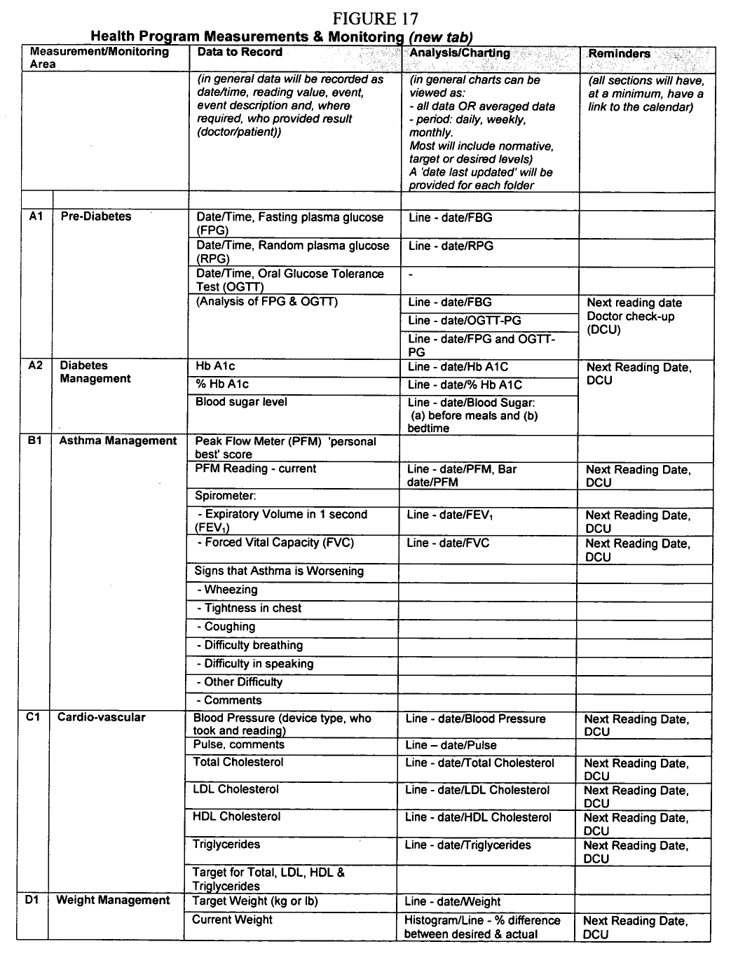

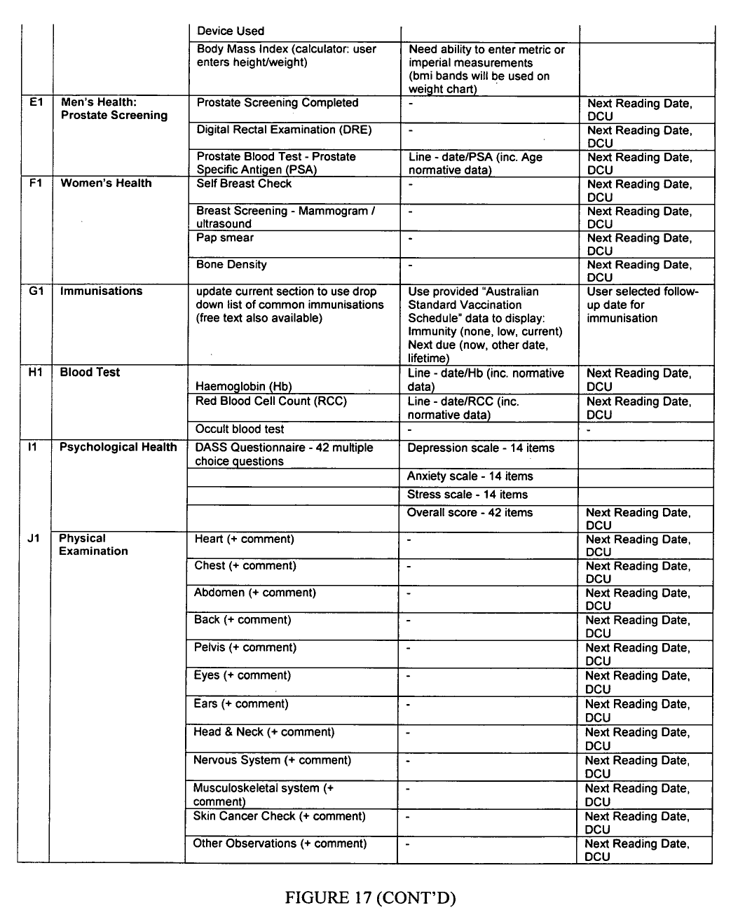

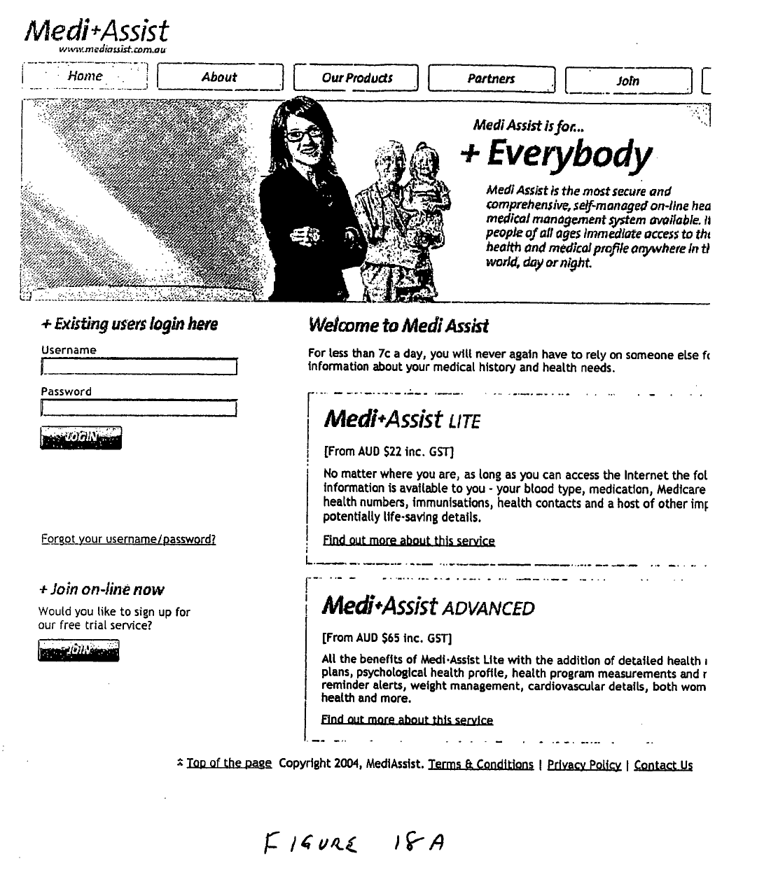

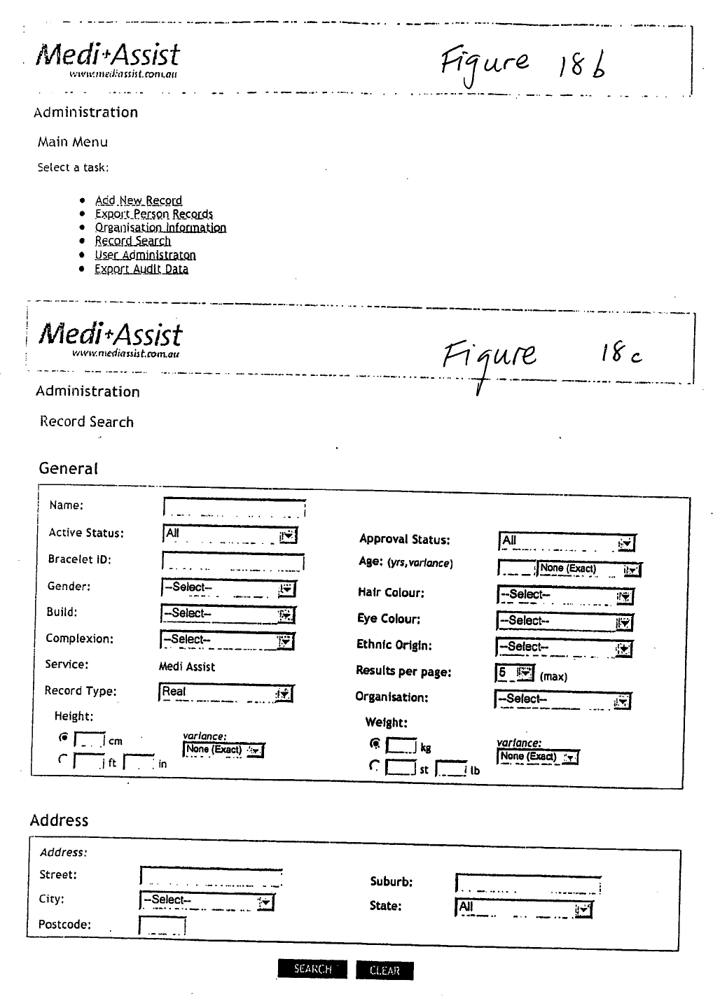

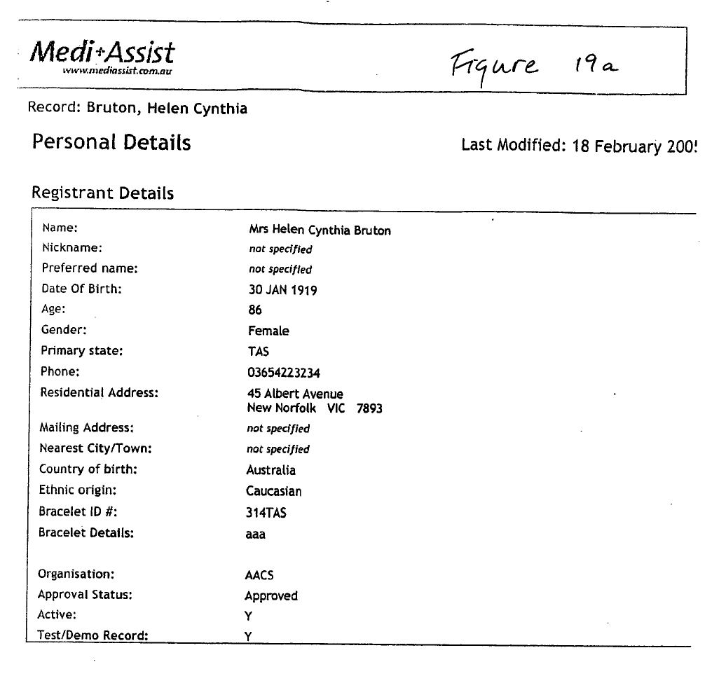

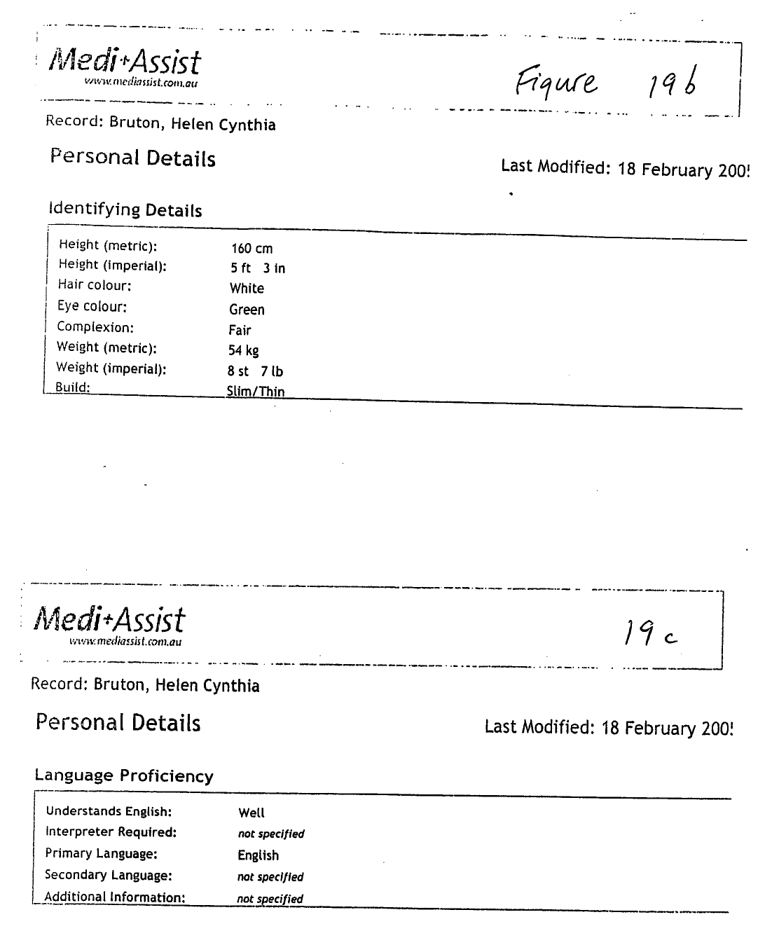

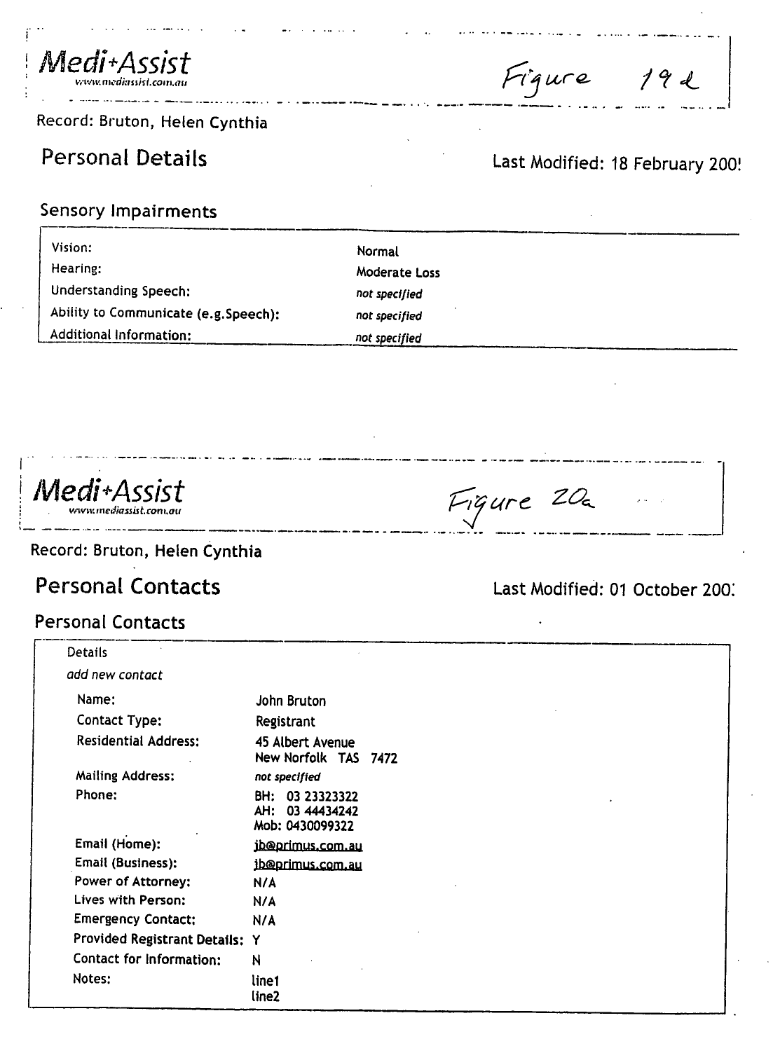

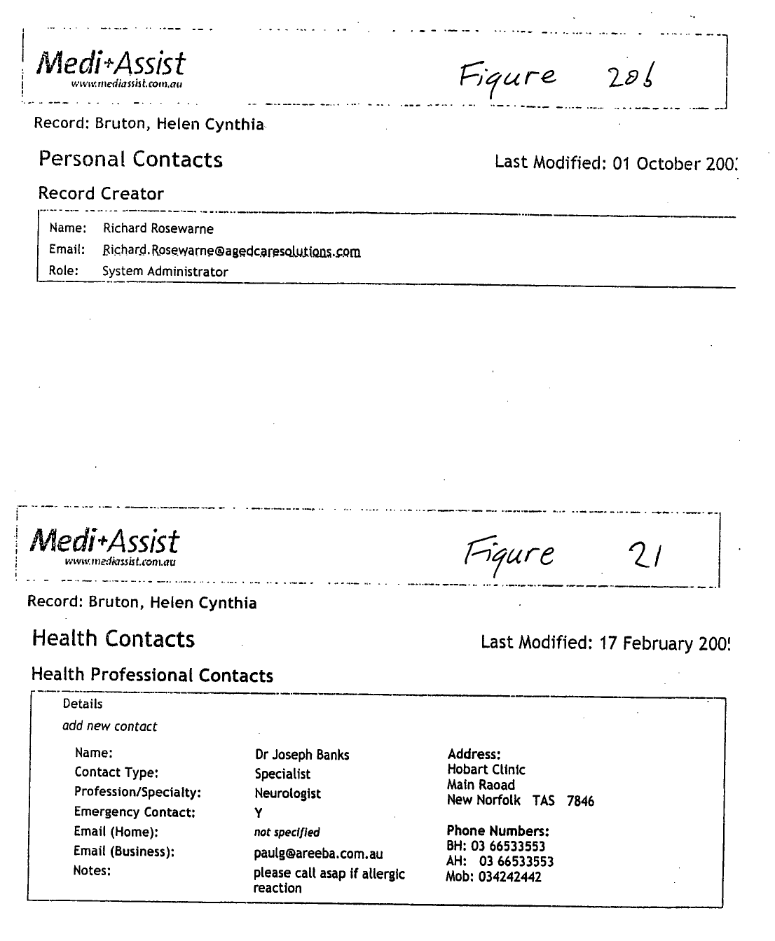

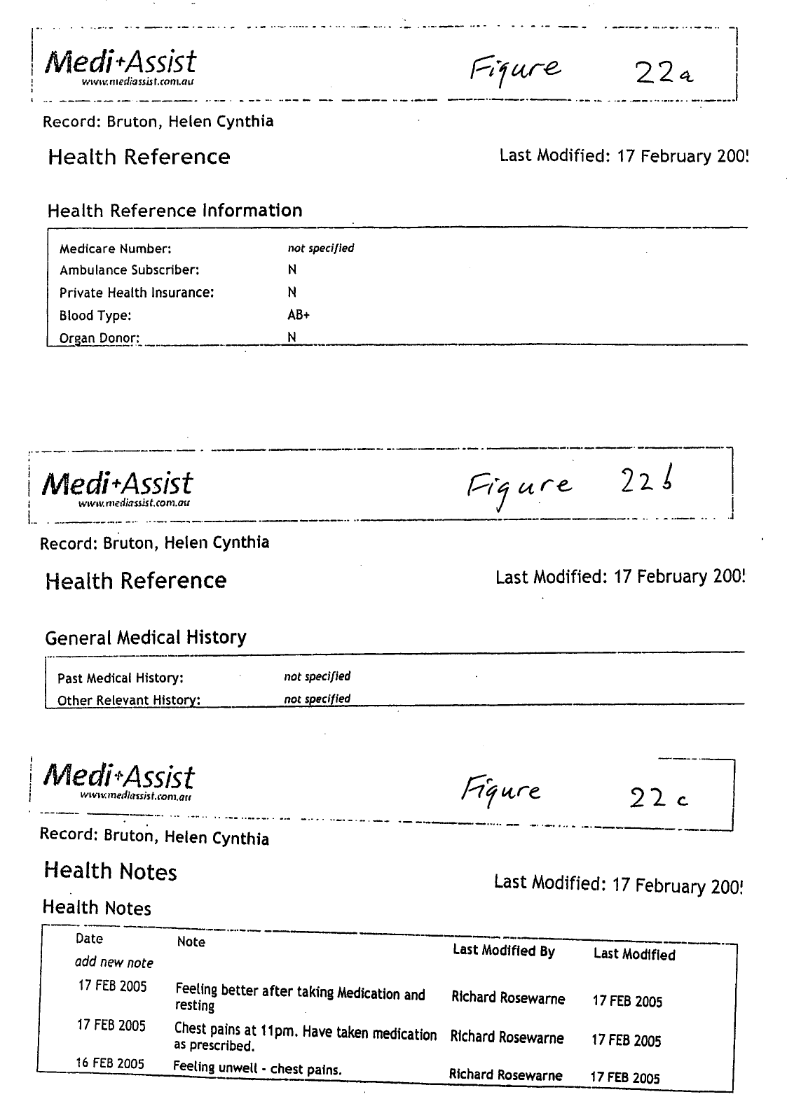

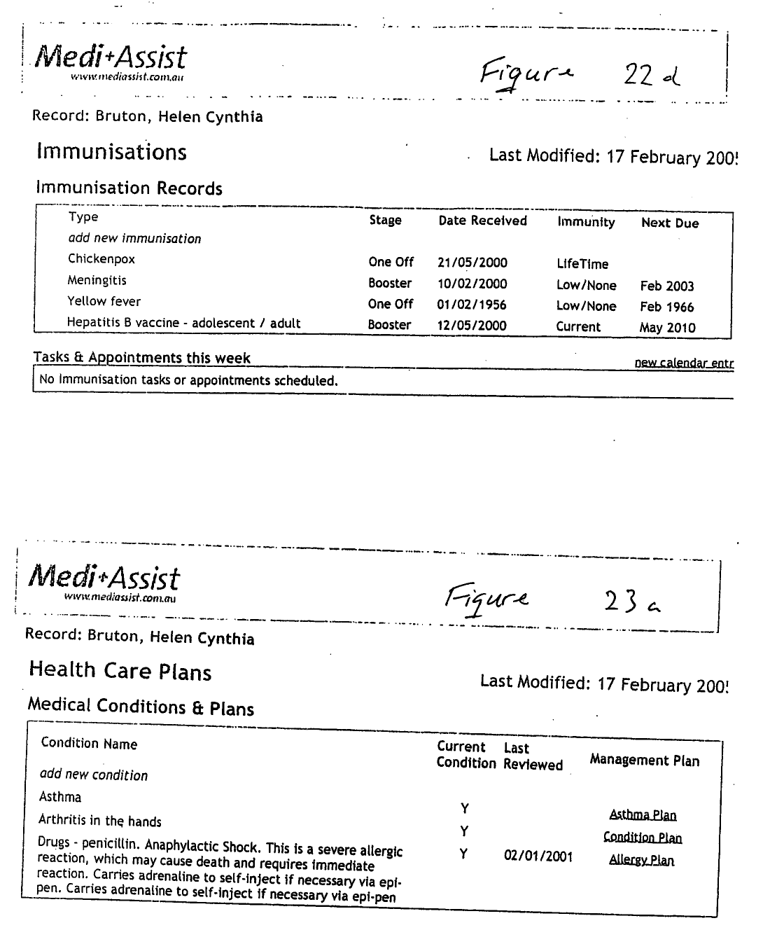

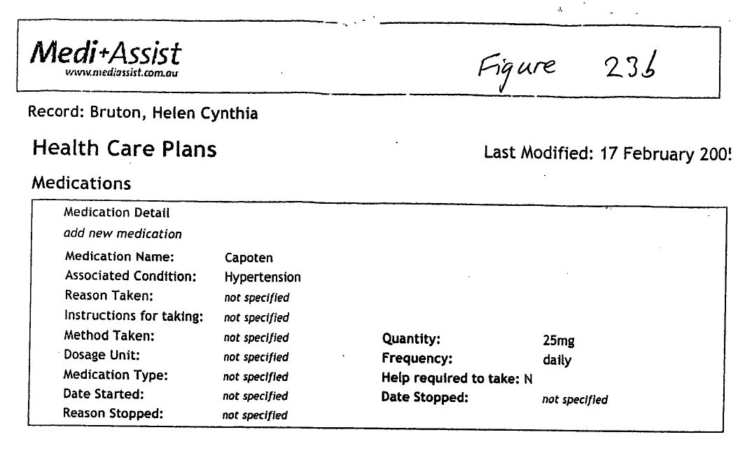

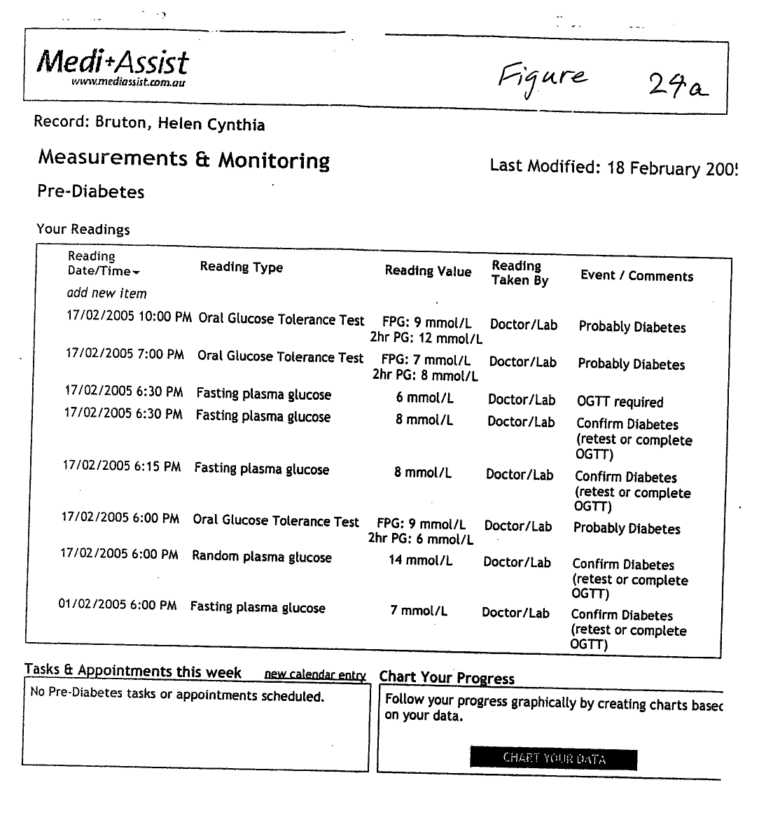

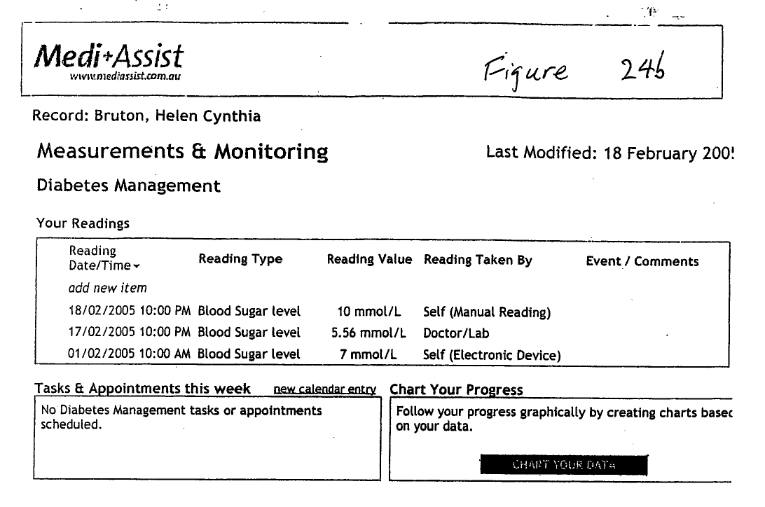

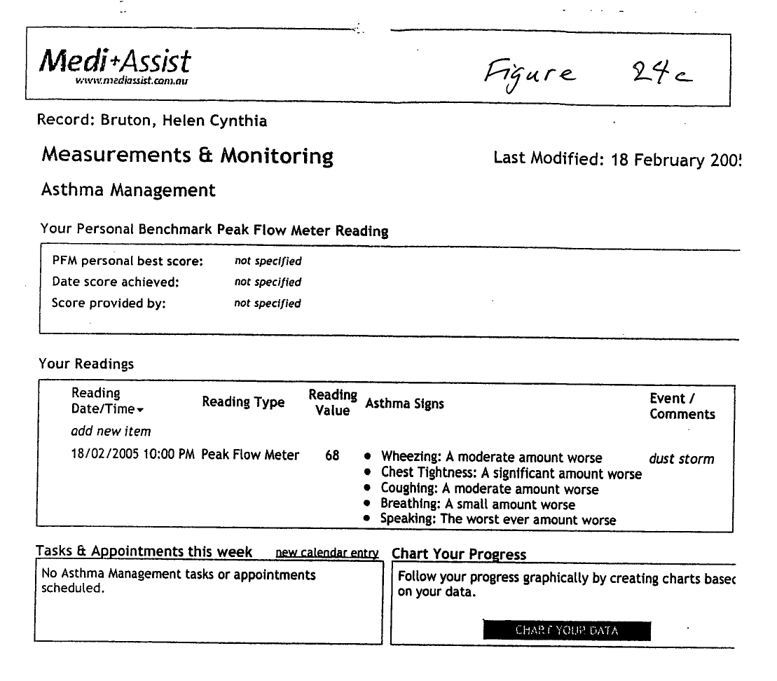

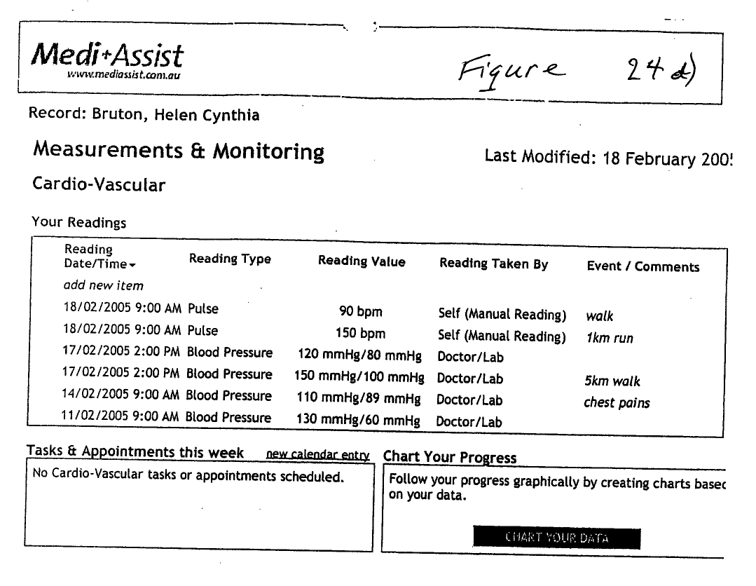

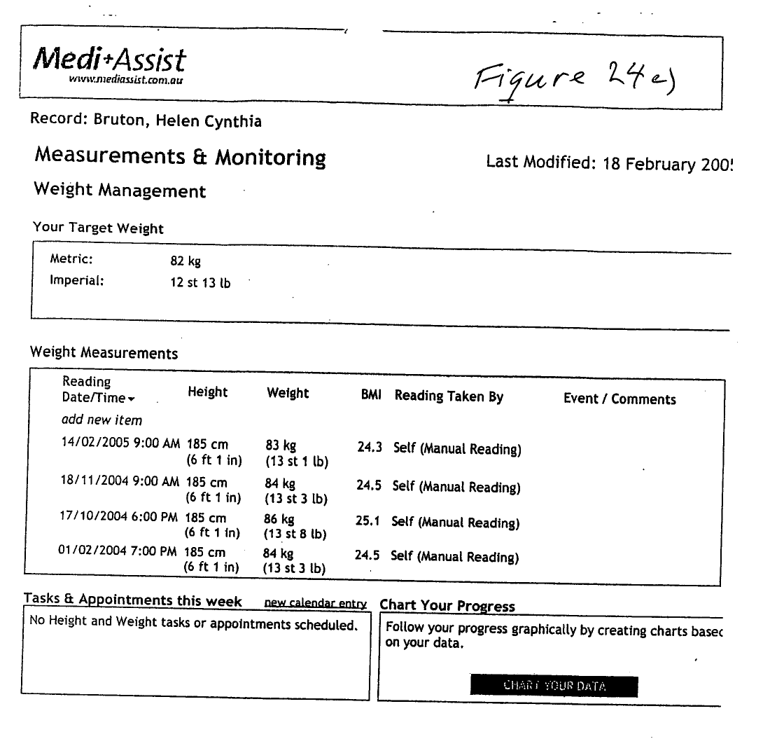

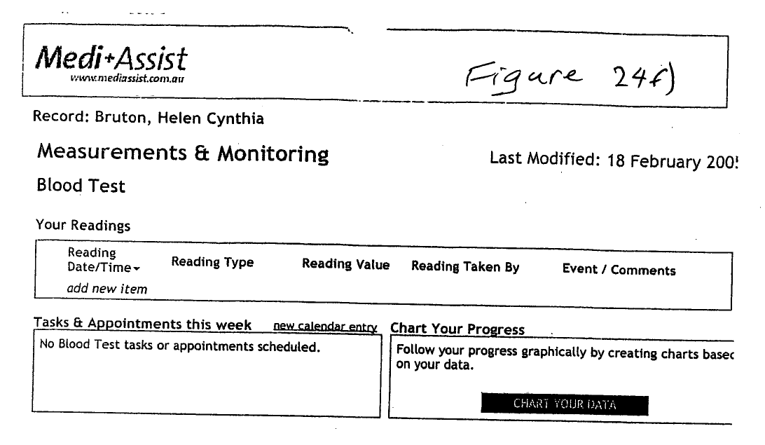

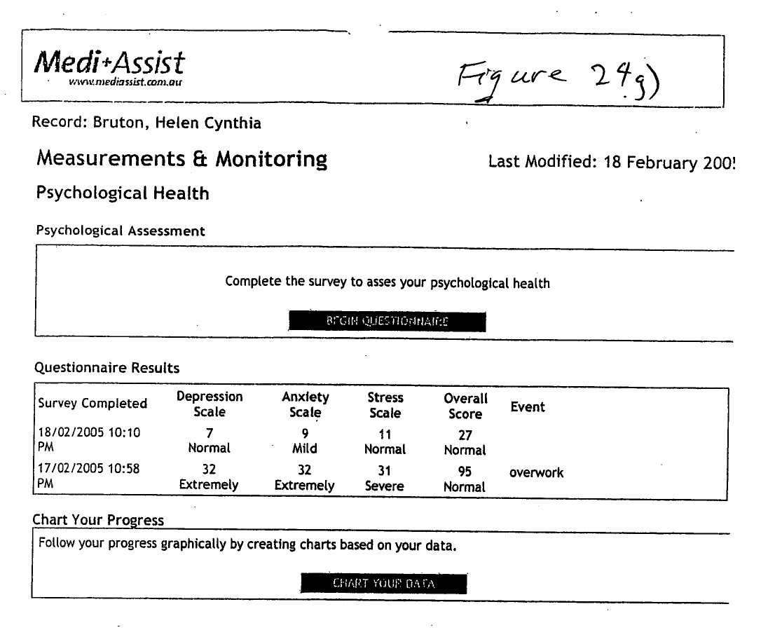

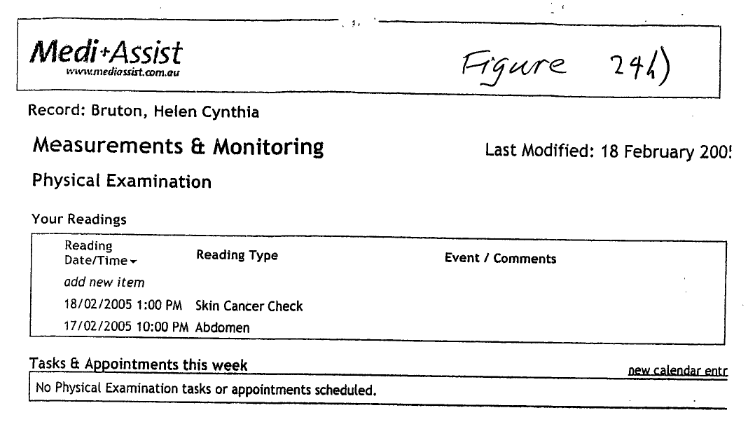

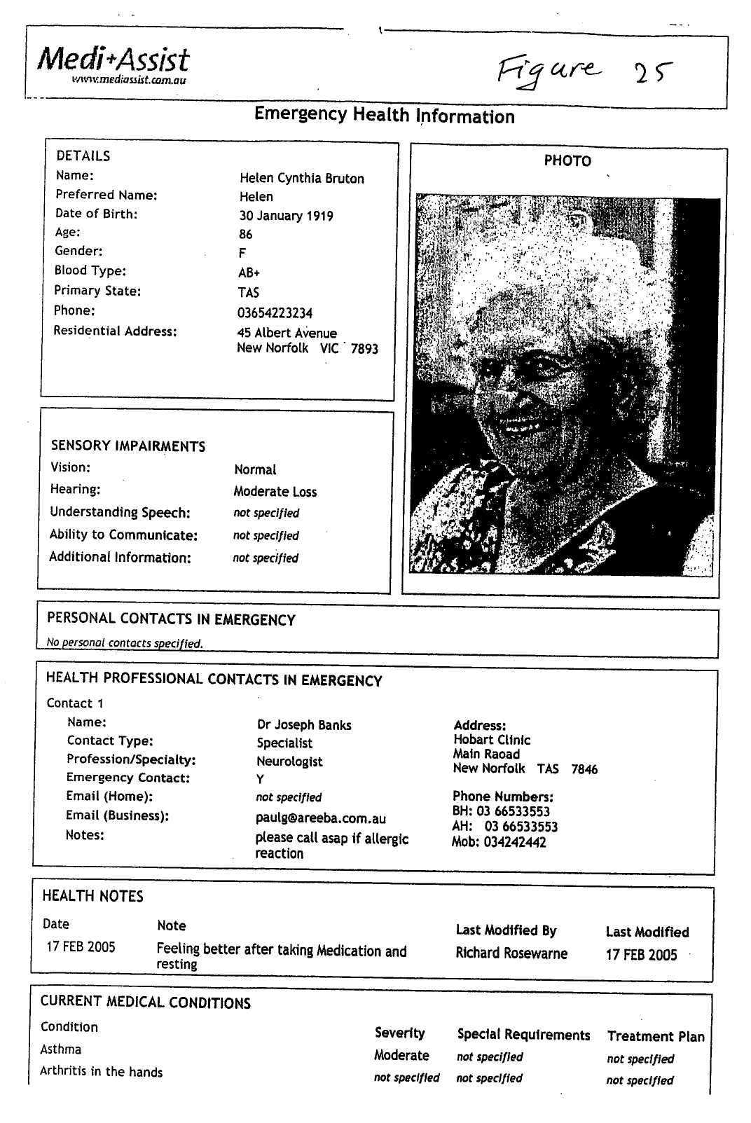

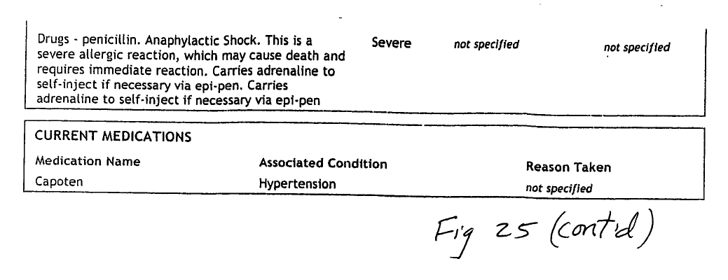

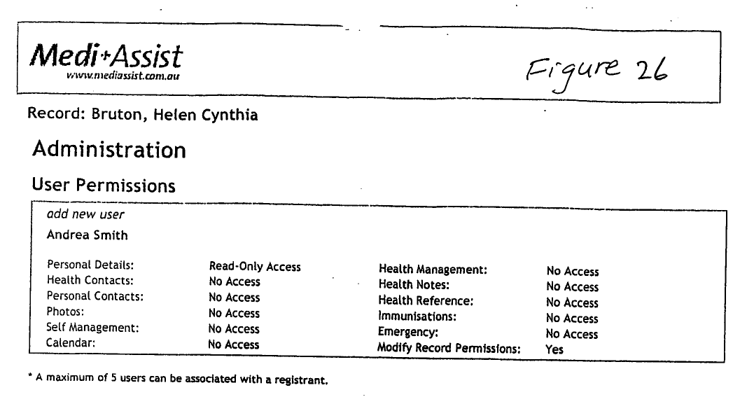

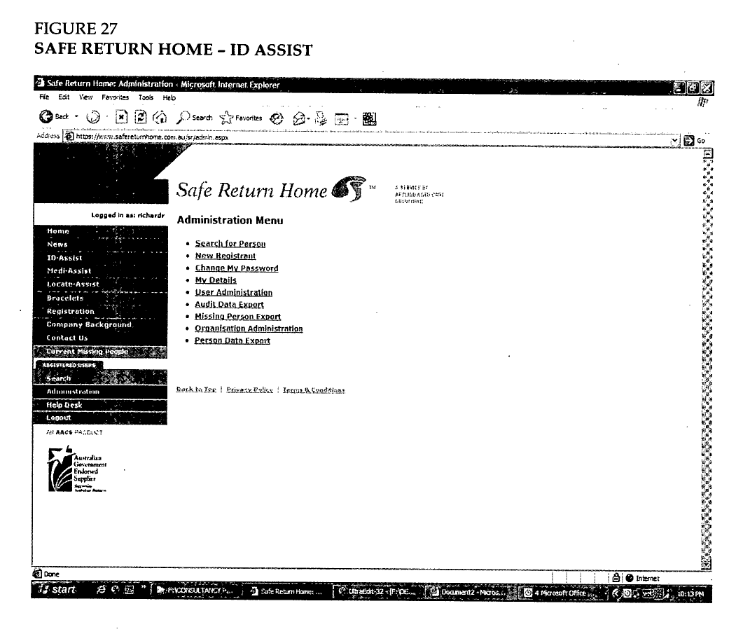

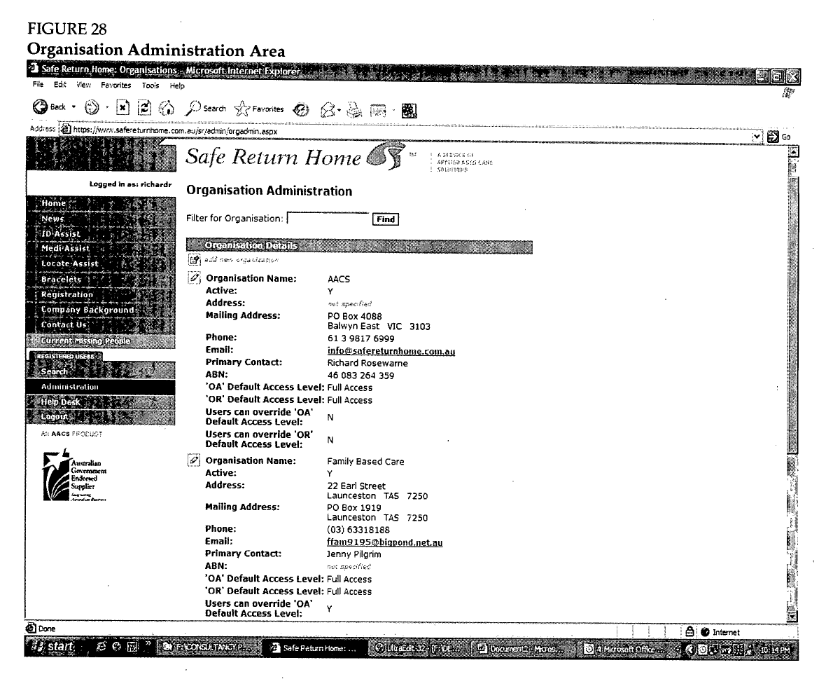

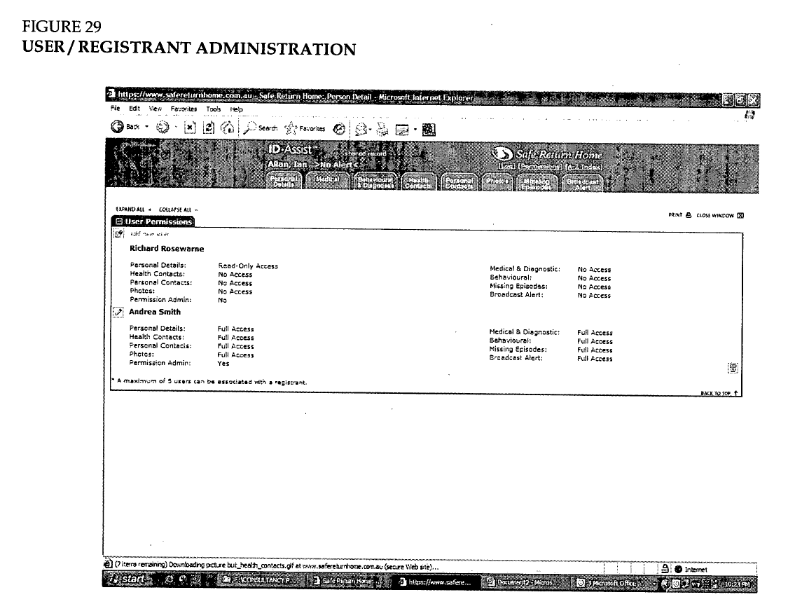

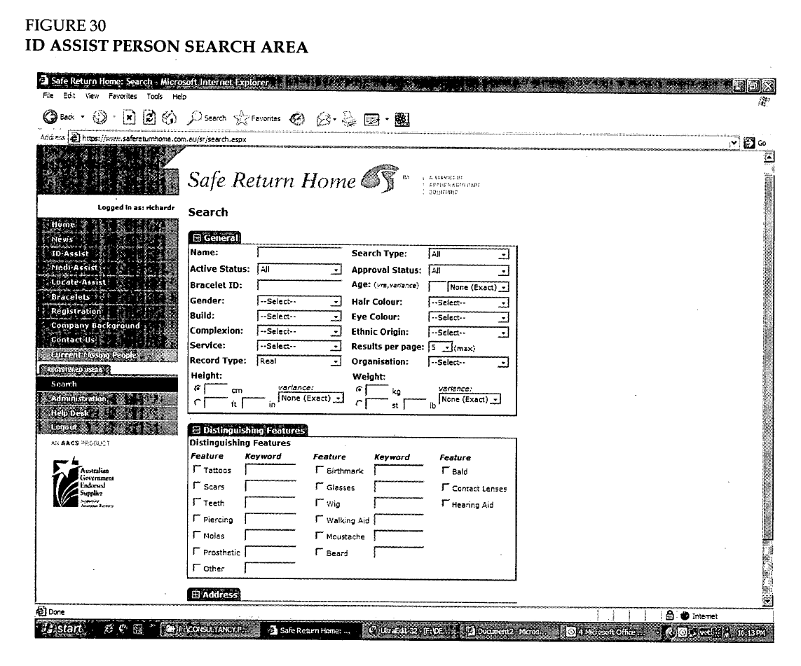

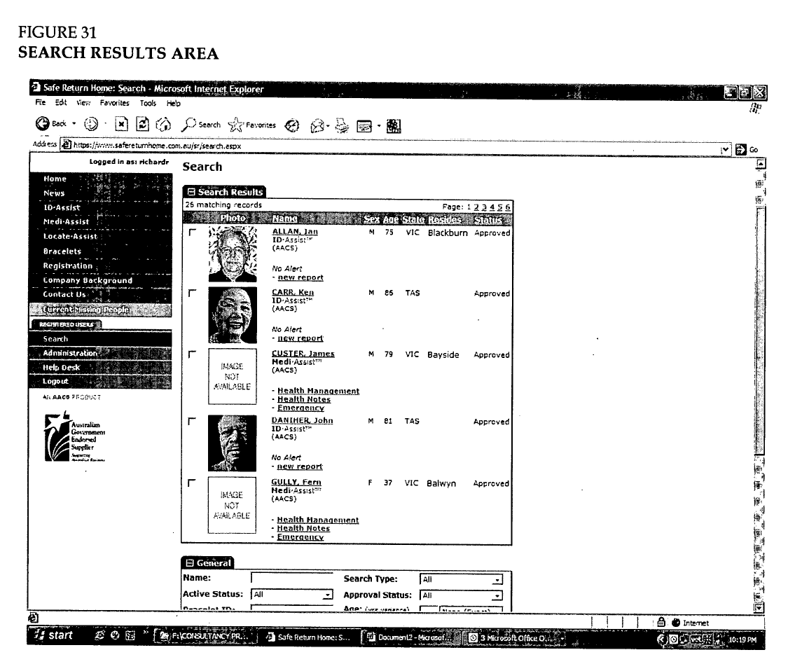

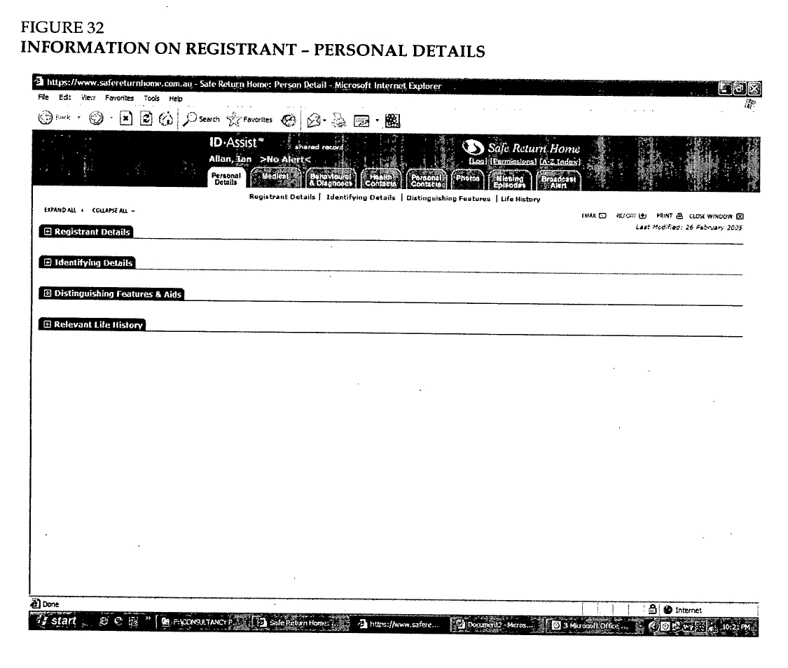

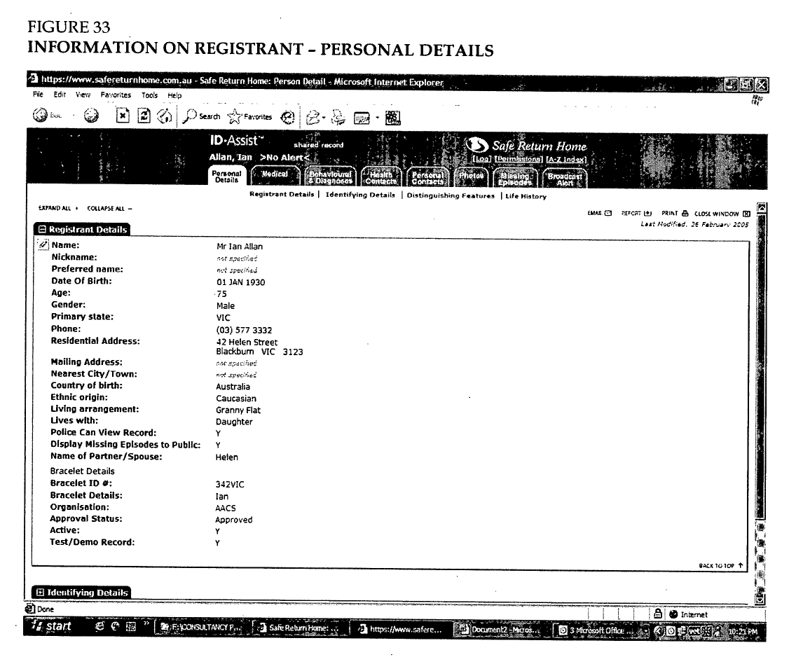

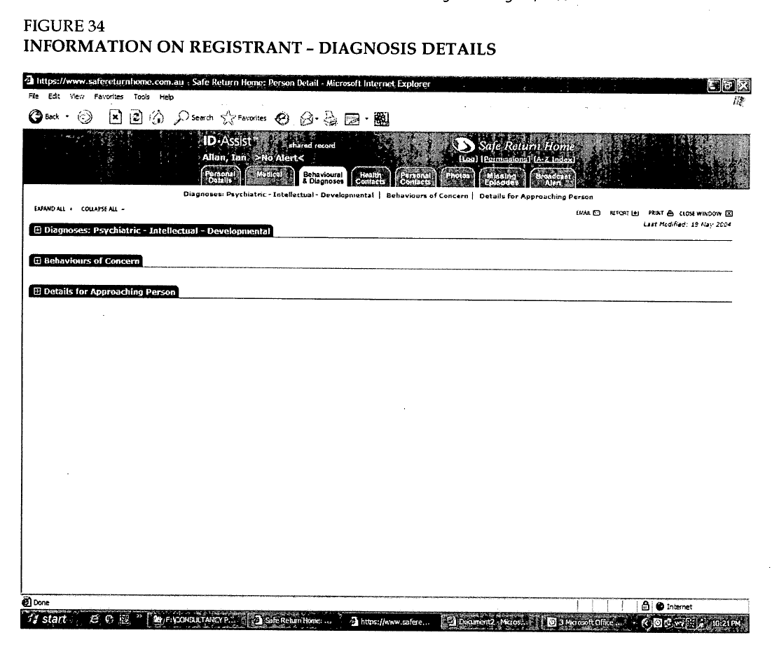

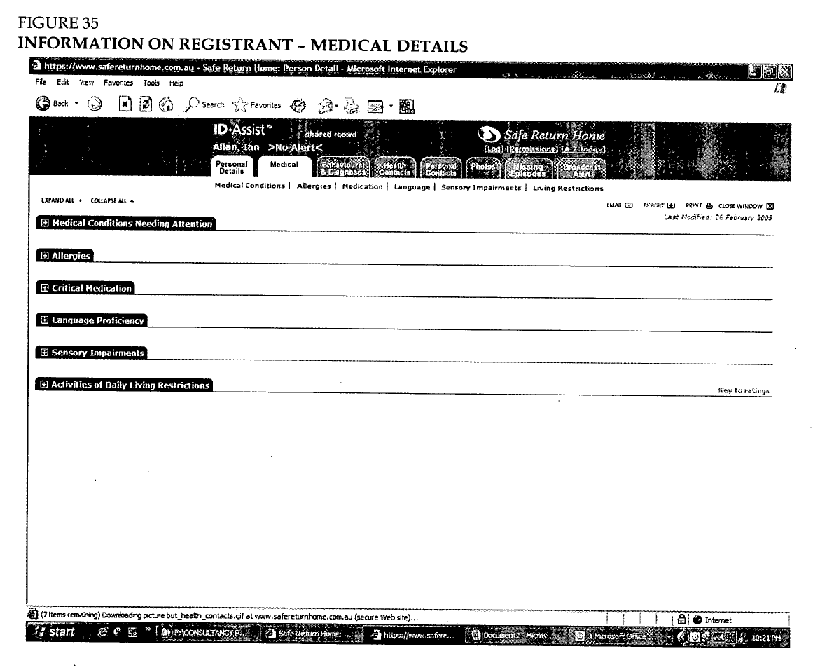

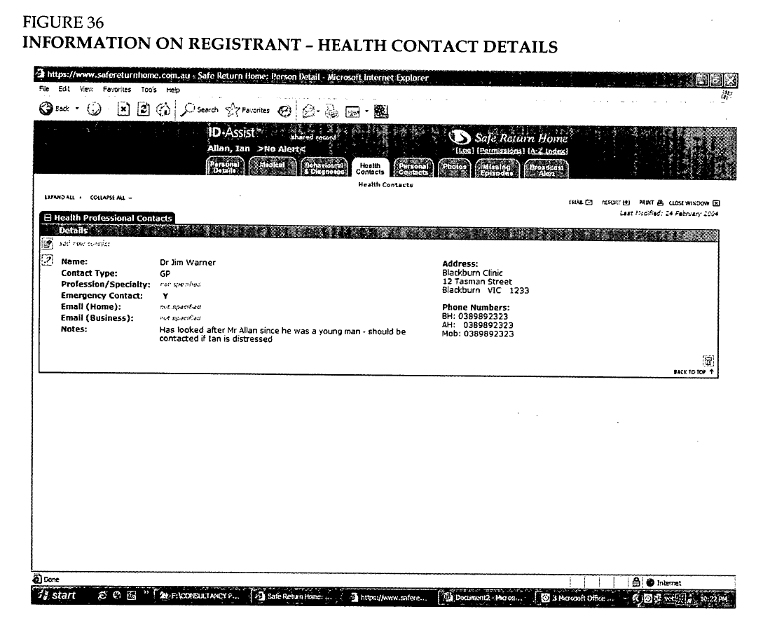

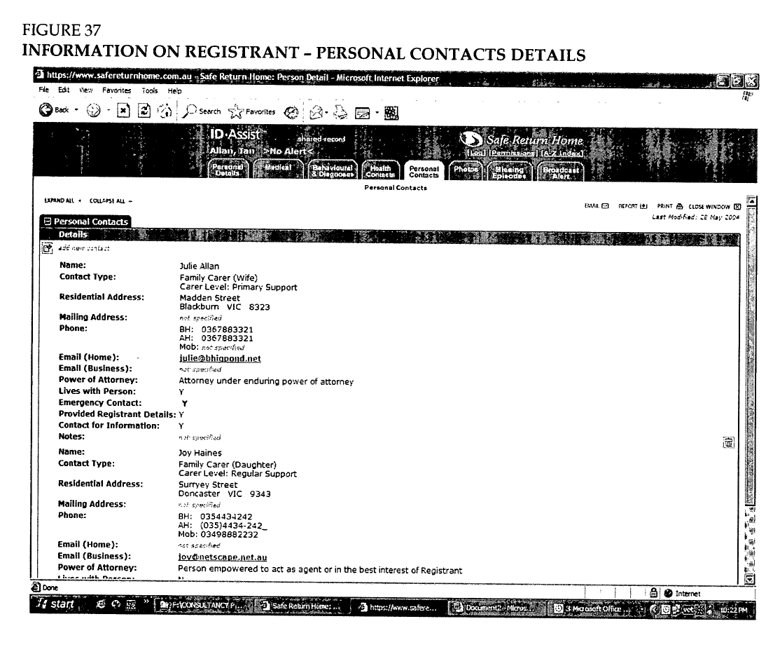

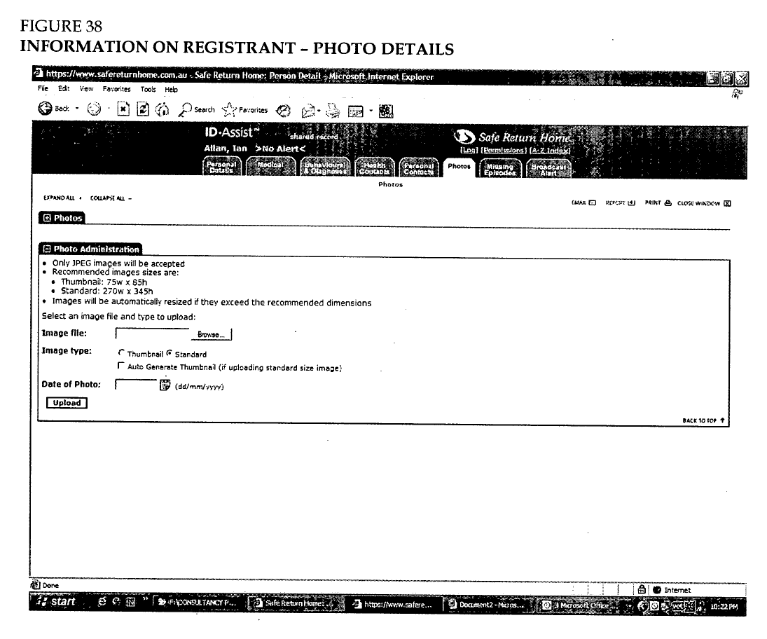

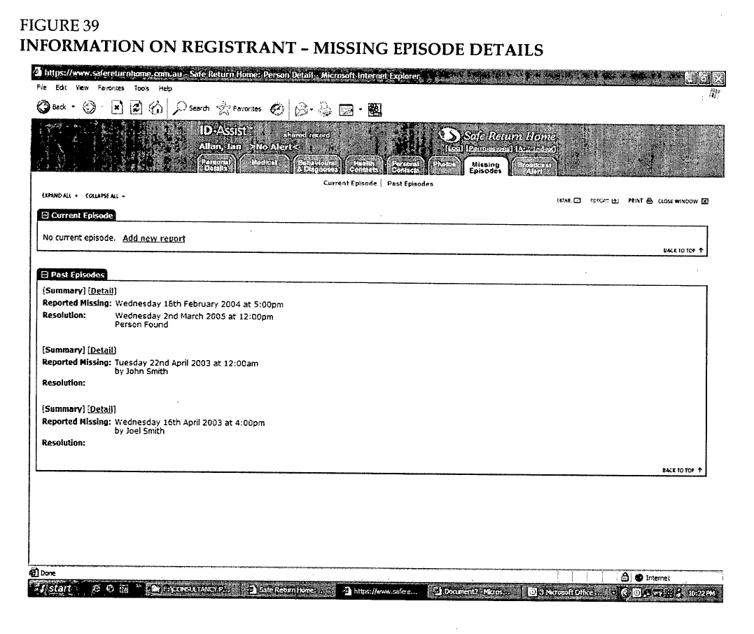

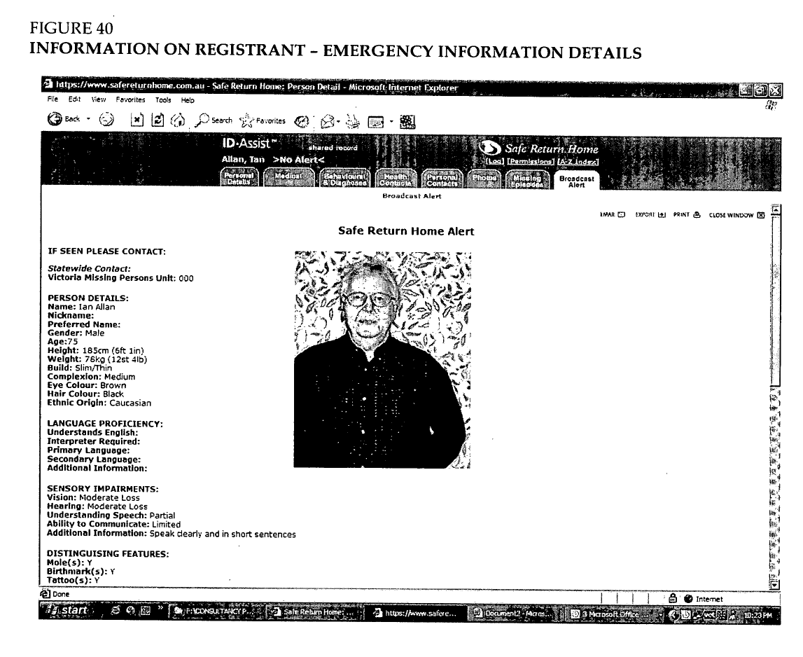

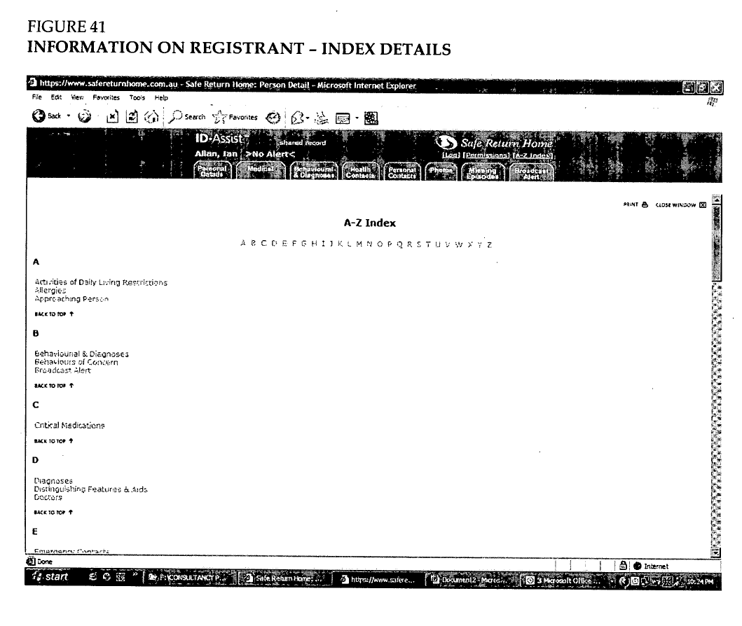

However a detailed form is shown in FIGS. 15, 16 and 17.

This facility is placed under a new Measurements & Monitoring tab, with each measurement area being implemented as a folder. Within each folder, the user will be able to view a paged list of their data, which can be filtered by a date range. If a measurement area collects more than one item or data, all items for a given date will be collected a displayed as a single line item. The data entered (excluding charts) into the Measurements & Monitoring tab will be available for HTML email and download as a Word compatible (RTF) file.

Health Care Appointment Reminders (set-up by patient but Dr has indicated date in the brochure handout). Patient uses to keep track of various:
Health Appointments
Follow-ups for particular health conditions with their Dr
Measurements that need entering in the Medi-Assist™ system (eg. once weekly weight measurement, blood glucose measurement etc)

Reminders can be set from within (i) Health Program Measurements & Monitoring sections or via email.

People who will want to register with the medical information service include:
People with complex medical conditions who need ready access to their information 24 hours/7 days a week
People with chronic medical conditions who need a current and historical account of their medications, purpose, side effects and efficacy
Families who wish to have a consolidated list of medical information available on their children with special medical needs
People travelling interstate or overseas who may need access to this vital information or provide it to medical services

The medical information is only accessed via the users confidential username and password. The user can distribute it using the following approaches:
1. email directly from the system
2. print off the information from the user web area and then fax
3. print off the information and mail

The medical assistance system of the invention includes a diary, travel section and have a health and wellbeing focus. In the advanced medical assistance system, registrants will be able to manage their progress on health indicators and chart any changes over time (eg. weight management).

Self management modules enable the information collected on health care areas to be used to determine a person ‘risk’ or other ‘health’ status. The system uses many different measurements to then determine this ‘risk’ or possible condition—the patient can then attempt to modify their health behaviour and use the system to plot the changes over time. This is the self management aspect. It also helps a person with a medical condition monitor their state and the system will provide a ‘warning’ to contact a DR if the measurements indicate a problem. The system can also generate an email or SMS the Doctor automatically.

### EXAMPLE

### School Use

The medical assistance system is ideal for those who wish to have their medical details securely stored for reference at any time. The system can assist schools, employers and other support organisations by coordinating health records in a secure, central internet accessible system.

The system can also be adapted as a student data management system. This will include addressing issues associated with privacy, data protocols, preparation of forms, reporting and data transfer.

The following benefits would result:
Improve management of student data including more efficient processes and professional documentation (current system uses photocopied forms and requires duplication of data entry).
Electronic data management for students would be a new service to offer schools as part of the school nursing service.
Following the successful pilot project, the healthcare initiative would provide new marketing opportunities for the school nursing service.
Opportunity to receive funding or sponsorship to reduce cost of service offered to schools.

Benefits to the school nursing services are the improved service capability and fresh opportunities for marketing and promotional activities that will be pursued with the new system. The current healthcare support provided to schools involves not only clinical management but also a complex paperwork system that is onerous, time consuming and places the nurse in a position of responsibility to the school, parents and children. In summary, the essential medical data communication system benefits will include:
The new system will replace the current ad-hoc paperwork system and provide an automated pathway for the nurse with the documentation, accountability and reporting requirements.
It will also improve the amount and access to clinical information available to the nurse—the system will be available “onsite” at the school and in off-site locations with internet access.
Health care information on students will be instantly accessible in one place—this will improve the responsiveness of the service.
Information can be printed off and filed as required.
All current paperwork such as reports regarding activity and type of tasks performed, reports to school principals and teachers and reports/letters to parents will be generated from the new system. This will save a significant amount of time and make for a more efficient and more accountable model than is currently the case.
The new system will enable a much more “shared care” approach to the school
Finally it will provide a strong basis on which to develop the school service and provide a compelling reason for other school to register for the service.

The benefits to schools include:
Health care information on students is easily accessible online and in one place, 24 hours a day, even when the nurse is not available. There is one central database with up-to-date health and medical information on students.
The information can be updated by parents at any time (eg. for excursions and school camps) and schools can check to see if parents have updated the information at the beginning of the year. Schools can update the computer records from paper information submitted by parents if they do not have computer/internet access.
School incidents that required intervention when the nurse was not available can be entered for reference when the nurse is next working.
Records can be printed off and taken on excursions, trips etc.
The system is accessible via the internet from anywhere in the world

The following provides some scenarios that demonstrate the benefit to schools:
a) A student has accident, health care need—requires intervention Teacher accesses system as needed via school intranet/internet. Medical details, parent and doctors information instantly available. The nurse, if available, uses the system to manage these episodes.
b) If at school camps & other remote campuses, then before leaving staff print off latest copy or simply access the web as required for information as needed. Students travelling overseas on excursions (also for teachers) simply access the web as required for information. The system has a ‘Health Notes’ section that enable online communication between medical personal—a local doctor in Melbourne with a doctor in an overseas location.
c) if students/parents overseas, parents can access the record and keep it up-to-date via international access via the web.

The benefits to parents include:
Non-replication of information. Parents only have to enter a complete set of health and medical information once when their child is first enrolled, after which the information only needs to be updated and not completely re-entered.

This information can be:
(i) provided by parents in paper form, to school for staff to data enter, or
(ii) entered by parents directly online via the web-interface
Parents can update this health/medical record at any time (record has last date of edit for view) via the web interface.
Parents can use the program's ‘administration area’ to give access to their local doctor if desired.
The health/medical record is available 24 hours a day for parents to use. This gives parents an additional benefit to participation in the program.
The reports to parents will be available ‘online’ as well as by a letter sent home. Parents will be able to ‘log on’ during the day if they wish to check on any updates provided by the nurse to a health care issue.

Worldwide password protected access is available 24/7 via the Internet. The system has developed special health information forms and health management plans in consultation with medical specialists, general practitioners and clinical nurses.

The user enters the information of the users choice directly to the user secure area on the medical assistance system. The user then has access via the Internet to the users essential medical information (eg. doctor contacts; medications; allergies; other special requirements). Registrants have this access 24 hours/7 days week from anywhere in the world using their unique username and password to access the Internet system. The user can enter edit, print and mail, or distribute via fax or email to appropriate services, medical authorities or hospital staff if needed in an emergency.

The system also has three levels of information to assist the user with the users medical information storage needs. The first is for general health and medical information (General Medical Information) and the second is via Medical Management Plans for conditions such as asthma or epilepsy and the third is via the Self management modules whereby information collected on health care areas is used to determine a person risk or other ‘health’ status. It also helps a person with a medical condition monitor their state and the system will provide a ‘warning’ to contact a DR if the measurements indicate a problem. The systems can also email or SMS the Doctor automatically.

The process comprises:
the user entering, editing, updating and controlling what information is stored—this is completed via the user administration module
all information is stored on a highly secure database located in a locked down facility. Secure 128 encryption is used for browser transmissions.
the user have the choice of printing off various pieces of information to give to medical staff, family, babysitters, school authorities, etc.
The medical assistance system provides the user with a very flexible way to collect and store the types of medical information required in emergencies, routine medical visits or for reference when the user are away from home, interstate or overseas.
   Registration Process

To register for the identification assist system by option 1 is by easy registration online comprising the steps of:
1. Select the internet database link;
2. Those registering online will be provided with a Username and Password after registration. The username and password will enable the registrant to create their online record of vital information.
3. Using the online entry method the user enter information directly into the confidential and secure system.
4. To enable access to the full the identification assist system (online editing & entry, printing, emailing), a consent form and payment form must be completed and faxed or mailed

Option 2 is a paper based entry system in which the provider enters the data for the user in a secure and confidential manner by the following steps:
1. Review the privacy policy and terms and conditions.
2. Print and complete the quick registration form (adobe pdf) for the identification assist system.
3. Print and complete the consent form (adobe pdf).
4. Include recent photos of the registrant (prints, negative, digital file). Best results will be obtained if a new digital photo/s is provided. Please contact the users local Camera Store or Camera store chains to have the user photo taken, processed, or converted to a digital format.
5. Print and complete the form (adobe pdf).
6. Mail or fax this completed information (quick registration, consent, payment forms)
7. The provider will then send the detailed the identification assist system registration form for completion. When the user has completed the Registration Form, it is returned for data entry in the user online record.

To register for medical assist system there is an easy registration online including the steps of.
1. Select the internet database link and register for medical assist system.
2. The user will be provided with a Username and Password after registration, which will allow for the creation of the users own record. The user can register more than one person in the user area at any one time (eg. multiple family members—children). However, a consent form must be completed for each registrant. Using the online entry method the user enter ALL health/medical information directly into the confidential and secure system.
3. To enable access to the full for medical assist system (online editing & entry, printing, emailing), a consent form and payment form must be completed and either faxed or mailed to the provider.
4. After processing (less than 10 days) the user will be given full access to set-up the user health and medical information in detail.

Examples A to J are summary modifications to the identification assist system form of the essential data communication system.

### Example A

The Essential data communication system is modified to enhance features such as navigation, help as well as some data capture and display elements.

Episode Reports

Add ability to allow or disable police creating/edit episode reports (currently Tasmanlia Police will be allowed, Victoria police will not)

Remove requirement for member of the police or SRH administrator to approve episode report prior to display on public website. (SRH administrators will still have the ability to change the approval status of a report in case it needs to be removed from the public website)

Only; display option to “List to Public” on report if the registrant/authorised contact has indicated that-reports can be displayed to public.

Broadcast Alert

Have the alert page always available, irrespective of whether or not a report has been completed.

Health Management/Medical & Diagnostic

Medical Conditions & Allergies

Essential medical data communication system: allows Merge Medical Conditions and Allergies to he displayed in the one summary list.

Medications

Essential medical data communication system: allows Add medication list under health management tab to allow users to add/edit medications both here and within specific medical plans.

Identification Assist & Essential medical data communication system allows to Add ability for user to add/edit a medication and choose to associate it with an existing condition or as a standalone item.

Registrant

Navigation

Adjust navigation so that when a user rolls over a particular tab (critical details, photos, etc), a menu of links to the folders of each section is displayed.

When the page loads and when the user is not currently rolling over any tabs, the menu displayed will be that of the currently selected tab.

Index

An “A-Z Index” of items, aliases and links to various sections of the registrant's record.

This system will be database driven (managed by a simple MS Access interface to the SQL Server database)

Each item will comprise of the following items: Link Text, Link Page (tab), Link Section (folder) and alias (text to appear alongside the link, but is not a link itself)

Help

Context sensitive help to be displayed in conjunction with each folder (located under the tabs)

This system will be database driven (managed by a simple MS Access interface to the SQL Server database)

Each help item will have the following associated items: Tab, Folder & Help Text

Note: It is envisaged that a third-party help system will be investigated at a later stage not in scope for this enhancement.

Security

Adjust security to allow users from the Victoria Police to be automatically signed in when they visit the Essential data communication system from a designated list of IP Addresses (to be supplied).

Any user originating from one of the designated IP addresses will be signed in (automatically) under a specific account (GP Role) created for the Victoria Police.

The Victoria Police will be given a specific page to link to on the Intranet in order to perform the automatic login. If a user requires to login in with a specific account (e.g. police system admin), they can go through the current login process.

### Example B

After initial use and feedback on the Essential data communication system, various modifications and enhancements are incorporated into the system. The aim of these enhancements is to further utilise the data captured in the system and to enrich the user experience.

Below is a list of the enhancements:

Broadcast Alerts

Add additional fields: Medical Conditions, Living Skills (Memory, Orientation, Outside Home Functioning, Personal Care, Mobility), date/time last seen, location last seen, last seen wearing

List of email addresses frequently used to email alert to. This will consist of:

Email addresses for the police missing persons unit and radio control room in the registered person's primary state

Previous 10 email addresses used by the currently logged in user

Emails alerts to have a html version (in addition to current text version)

Person Data Export (download):

Add a facility for the currently logged in user to generate a MS Word compatible (RTF) document containing the stored data for a registrant. The document generated will either be:

All information stored for a registrant i.e. Critical Details AND Medical & Diagnostic AND Behavioural AND Caregiver Details AND Missing Details

Information applicable to the current section (tab) the user is viewing. i.e. Critical Details OR Medical & Diagnostic OR Behavioural OR Caregiver Details OR Missing Details

Person Data Export (email):

The email facility will configured similar to the broadcast section, whereby a user can enter an email address or select an address from a frequent email address list, then send the data.

As with the download version, the user will have the option to send either all of the information stored for a registrant, or just the current selected section.

Emails will be sent in HTML format.

Audit/Log Data Export:

Police System Administrators (SP role) will have the ability to obtain an export in CSV format of audit/log data for all police within their state. The user will have the option to filter the export by a date range.

Caregivers (Contacts):

Adjust to functionality of this section to be more generic, i.e. contacts.

As a contact may not necessarily be a caregiver, current requirements for caregiver specific data are to be removed.

Ability for a registrant to be a contact to be incorporated.

Add mailing address fields

Add/Adjust flags to indicate if: Emergency Contact, Contact for Information, Provided Registrant Details and/or Billing Contact

Medical and Diagnostic:

Adjust “Critical Medications” section to capture and display: Medication Name, Associated Medical Condition, Dosage, Unit, Times/day and Route.

Add description fields to accompany dementia diagnosis, developmental disability and psychiatric diagnosis

Billing/Administration:

In the Administration tool, add a facility to record payment transactions against a registrant. The items collected in the transaction table will be:

Date

Item (list of items, e.g. subscription, bracelet)

Unit Cost

Quantity

Total Cost

Reference Number

Payment Method (Credit Card, Cheque, Money Order, EFT)

Notes

In addition to the transaction data, additional fields will be added to a registrant to store a history of their subscription start date and subscription length (choice of 1, 2 or 3 years).

Once the subscription data has been entered into the database, a set of automated scripts will run on the server to check if a registrant is due for an information check or if their subscription is due for renewal.

The script on the server will run weekly and it will check for people due to receive a 6 monthly details check. If this is the case, an email will be sent to the SRH system administrator alerting them of all the registrants whose details are to be followed up.

The weekly server script will also check the registrant's subscription expiry date. An alert will be sent to the SRH system administrator 8 weeks prior to the expiration date in order for a renewal notice to be organised.

If the subscription is not renewed, follow up alerts will be sent to the SRH administrator 1 week prior to expiration and 2 weeks after expiration. If a subscription remains overdue for 1 month, the registrant's record will be marked as inactive.

The MS Access administration tool will be modified to accommodate the subscription and follow-up dates.

These modifications will allow for a history of phone calls/contacts, record modifications and notes to be stored against each registrant. An option will be made available to reset the next review date to 6 months in advance of the history item date.

Two reports will be created in the MS Access tool to show a list of people due to be contacted for 6 monthly follow up reviews, and second report to show people due for subscription renewals in the near future.

General/Miscellaneous: Add option to allow/disallow police to view a registrants details

Add last modified date to the database records of key tables.

The key tables are those directly holding data about a specific person such as their critical details, medical, behavioural, caregiver/contact, episode reports and billing contacts. (tables used as lookups will be not have the last modified data applied)

Display last modified date per tab (Critical Details, Medical & Diagnostic, etc.) Search: add a “variance” option to Age, add description to moustache and beard LHS Menu: Adjust button text (unselected/normal) to be stronger

### Example C

The Essential data communication system is modified to enhance features such as navigation, help as well as some data capture and display elements.

Episode Reports

Add ability to allow or disable police creating/edit episode reports (currently Tasmania Police will be allowed, Victoria police will not)

Remove requirement for member of the police or SRH administrator to approve episode report prior to display on public website. (SRH administrators will still have the ability to change the approval status of a report in case it needs to be removed from the public website)

Only display option to “List to Public” on report if the registrant/authorised contact has indicated that reports can be displayed to public.

Broadcast Alert

Have the alert page always available, irrespective of whether or not a report has been completed.

Health Management/Medical & Diagnostic

Medical Conditions & Allergies

Essential medical data communication system: Merge Medical Conditions and Allergies to be displayed in the one summary list.

Medications

Essential medical data communication system: allows to Add medication list under health management tab to allow users to add/edit medications both here and within specific medical plans.

Identification Assist & Essential medical data communication system

Add ability for user to add/edit a medication and choose to associate it with an existing condition or as a standalone item.

Registrant

Navigation

Adjust navigation so that when a user rolls over a particular tab (critical details, photos, etc), a menu of links to the folders of each section is displayed.

When the page loads and when the user is not currently rolling over any tabs, the menu displayed will be that of the currently selected tab.

Index

An “A-Z Index” of items, aliases and links to various sections of the registrant's record.

This system will be database driven (managed by a simple MS Access interface to the SQL Server database)

Each item will comprise of the following items: Link Text, Link Page (tab), Link Section (folder) and alias (text to appear alongside the link, but is not a link itself)

Help

Context sensitive help to be displayed in conjunction with each folder (located under the tabs)

This system will be database driven (managed by a simple MS Access interface to the SQL Server database)

Each help item will have the following associated items: Tab, Folder & Help Text

Note: It is envisaged that a third-party help system will be investigated at a later stage not in scope for this enhancement.

Security

Adjust security to allow users from the Victoria Police to be automatically signed in when they visit the Essential data communication system from a designated list of IP Addresses (to be supplied).

Any user originating from one of the designated IP addresses will be signed in (automatically) under a specific account (GP Role) created for the Victoria Police.

The Victoria Police will be given a specific page to link to on the Intranet in order to perform the automatic login. If a user requires to login in with a specific account (e.g. police system admin), they can go through the current login process.

### Example D

The Essential data communication system is modified to incorporate branding changes as well as some lathe user and data re-organisation.

Graphic Design

1. Branding/artwork for ID-Assist and Medi-Assist services

2. Integrate the new logos into the following items:

Forms: Pay, ID-Assist Consent & Medi-Assist Consent

Essential identification data communication system pamphlet

Website

Website

1. Essential data communication system secure section: the following text and graphic references are to be altered:

Essential medical data communication system to Medi-Assist; and

Identification Assist to ID-Assist

2. Tabs:

Label Changes (applies to both ID-Assist & Medi-Assist) Critical Details to Person Details and Contacts to Personal Contacts

New Tabs

Health Contacts (applies to both ID-Assist & Medi-Assist): Move Health Professional Contacts folder from Health Management

Health Reference (applies to Medi-Assist only):

Move Health Reference folder from Health Management

Immunisations (applies to Medi-Assist only): Move Immunisations folder from Health Management

Tab Order for Medi-Assist will be:

Person Details, Health Management, Immunisations, Health Reference, Health Notes, Health Contacts, Personal Contacts, Photos

3. Data:

Health Professional Contacts: Add field “Contact In Emergency” (Yes/No) and emphasis any contacts with this attribute set.

Registrant Record/Search Results/My Records: Add text to show which service registrant is subscribed to

Demographics: Modify facility/address behaviour so that when a user selects a facility, the registrant's address is pre-populated and can subsequently be modified by the user.

4. Search & Administration:

Add ability to filter for registrants based on subscribed service (ID-Assist or Medi-Assist)

Display approval status for administrators and caregivers/contacts

Add facility to non-approved registrants in search results so that administrator can bulk select and change their approval status.

Send email to registrant contacts when their approval status is changed

### Example E

The Essential data communication system is modified to incorporate branding changes as well as some lathe user and data re-organisation.

Graphic Design

1. Branding/artwork for ID-Assist and Medi-Assist services

2. Integrate the new logos into the following items:

Forms

Essential identification data communication system pamphlet

Website

Website

3. Essential data communication system secure section: the following text and graphic references are to be altered:

Essential medical data communication system to Medi-Assist; and

Identification Assist to ID-Assist

4. Tabs:

Label Changes (applies to both ID-Assist & Medi-Assist)

i. Critical Details to Person Details

ii. Contacts to Personal Contacts

New Tabs

i. Health Contacts (applies to both ID-Assist & Medi-Assist):

Move Health Professional Contacts folder from Health Management

ii. Health Reference (applies to Medi-Assist only):

Move Health Reference folder from Health Management

iii. Immunisations (applies to Medi-Assist only):

Move Immunisations folder from Health Management

Tab Order for Medi-Assist will be:

Person Details, Health Management, Immunisations, Health Reference, Health Notes, Health Contacts, Personal Contacts, Photos

5. Data:

Health Professional Contacts: Add field “Contact In Emergency” (Yes/No) and emphasis any contacts with this attribute set.

Registrant Record/Search Results/My Records: Add text to show which service registrant is subscribed to

6. Search & Administration:

Add ability to filter for registrants based on subscribed service (ID-Assist or Medi-Assist)

Display approval status for administrators and caregivers/contacts

Add facility to non-approved registrants in search results so that administrator can bulk select and change their approval status.

Send email to registrant contacts when their approval status is changed

### Example F

The Essential data communication system is extended to contain a “Essential medical data communication system” facility. The addition of this functionality will assist in the expansion of Essential data communication system and allow for a broad user base to take advantage of a new set of facilities. This facility enables users to store and share detailed health and medical information about themselves or a registrant for which they are associated.

The purpose of the Essential medical data communication system facility is to store and provide detailed medical information about a registrant.

The “Essential medical data communication system” facility will consist of an additional tab being placed within the SRH person detail popup screen. The addition of this facility to the SRH system will mean that potential registrants can register for one or both of the Identification Assist and Health Management services.

Depending on the subscription level selected, an end user will see the following tabs in relation to a registrant:

Identification Assist Only:

Critical Details, Medical & Diagnostic, Behavioural, Photos, Contact Details, Missing Episodes & Broadcast Alert

Health Management Only:

Critical Details, Health Management, Behavioural, Photos, Contact Details,

Identification Assist AND Health Management:

Critical Details, Medical & Diagnostic, Behavioural, Photos, Contact Details, Missing Episodes & Broadcast Alert, Health Management

Registrants utilising the “Essential medical data communication system” service, will have an option made available as to whether or not the police can view their information (default is for police NOT to see the information).

This Health Management tab will consist of the following elements:

1. Medical Conditions (GPs, Specialists)

As per current SRH Medical & Diagnostic format

2. Medical Conditions (Multiple Conditions)

Field: Name, Related Conditions or Complications, Triggers/Warning Signs/Symptoms, Severity of Condition (mild, moderate, severe, other), Special Requirements (e.g. dietary), Treatment Plan for Medical Condition, History of Medical Condition, When Condition First Diagnosed, Who Diagnosed Condition, Other Information

3. Allergies

Field: Type of Allergy, Triggers/Warning Signs/Symptoms, Severity of Allergy (mild, moderate, sever, other), Special Requirements (e.g. dietary/must carry medication at all times), Treatment Plan, History of the Allergy from Diagnosis until Now, When Allergy First Diagnosed, Who Diagnosed Allergy, Other Information.

4. General Medical History

Field: Past medical history (dates, surgery)n m, Other relevant history, Blood Type (A+, A−, B+, B−, AB+, AB−, O+, O−),

5. Immunisation History

Field: Type, Date Received

6. Medications

Field: Name, Quantity, Dosage Unit, Frequency, Route Taken, Date Started

7. Previous Medications

Field: Name, Reason Medication Taken, Reason Medication Stopped

Administration

Option 1—MS Access

To facilitate the addition and maintenance of a registrant's health management data, the current MS Access Administration tool would be extended to contain additional forms and queries to interface with the data.

Option 2—Web Based

In order to allow registrants and their associated contacts to maintain the health data, a web based interface would be developed. The interface to enable information updates will consist of the following elements:

Registrant Details: Title, First Name, Middle name, Surname, Nickname, Preferred Name, Gender, Date o Birth, Residential & Mailing Address, Telephone Numbers, Home/Work Email, Bracelet Details, Languages Spoken & Sensory Impairments.

Medical Contacts: GP & Specialist Name, Clinic, Address, Phone

Contact Details: Primary & Second Contact Name, Telephone Numbers, Residential and Mailing Address, Home/Work Email, Relationship, If lives with registrant, legal authority status, flags to indicate if person is a contact in emergency, contact for information, or provided registrant details.

Medical Conditions (Multiple):

Name, Related Conditions, Triggers/Warning Signs/Symptoms, Severity, Special Requirements, Treatment Plan, History, When Diagnosed, Who Diagnosed Condition, Other Information. Medications (current)—name, quantity, dosage unit, frequency, route take, date started Medications (previous)—name, reason taken, reason stopped

Allergies:

Type of Allergy, Triggers/Warning Signs/Symptoms, Severity, Special Requirements, Treatment Plan, History, When Diagnosed, Who Diagnosed Allergy, Other Information. Medications (current)—name, quantity, dosage unit, frequency, route take, date started Medications (previous)—name, reason taken, reason stopped

General Medical History:

Past medical history (dates, descriptions), Other relevant history, blood type

Immunisation History: Date(s) Received, Type

### Example G

The Essential data communication system has been extended to contain a “Essential medical data communication system” facility. The addition of this functionality will assist in the expansion of Essential data communication system and allow for a broad user base to take advantage of a new set of facilities. This facility will enable users to store and share detailed health and medical information about themselves or a registrant for which they are associated.

In addition to the Essential medical data communication system facility, the identification assist portion of the website has been enhanced to allow users to maintain the data stored for a particular registrant.

Essential Medical Data Communication System Module

The purpose of the Essential medical data communication system facility is to store and provide detailed medical information about a registrant.

The “Essential medical data communication system” facility will consist of an additional tab being placed within the SRH person detail popup screen. The addition of this facility to the SRH system will mean that potential registrants can register for one or both of the Identification Assist and Health Management services.

Depending on the subscription level selected, an end user will see the following tabs in relation to a registrant:

Identification Assist only: Critical Details, Medical & Diagnostic, Behavioural, Photos, Contact Details, Missing Episodes & Broadcast Alert

Health Management only: Critical Details, Health Management, Photos, Contact Details

Identification Assist AND Health Management: Critical Details, Medical & Diagnostic, Behavioural, Photos, Contact Details, Missing Episodes & Broadcast Alert, Health Management

Registrants utilising the “Essential medical data communication system” service, will have an option made available as to whether or not the police can view their information (default is for police NOT to see the information).

This Health Management tab will consist of the following elements:

1. Medical Conditions (GPs, Specialists)

As per current SRH Medical & Diagnostic format with the addition of a field detailing a medical professional's profession/specialty.

2. Medical Conditions (Multiple Conditions)

Field: Name, Related Conditions or Complications, Triggers/Warning Signs/Symptoms, Asthma Management Plan—triggers (exercise, cold/viruses, pollens, dust, food, other)—Signs (wheezing, tightness of chest, coughing, difficulty breathing, difficulty speaking, other)—Signs when worsening (wheezing, tightness in chest, coughing, difficulty in breathing, difficulty in speaking, other), Severity of Condition (mild, moderate, severe, other), Special Requirements (e.g. dietary), Treatment Plan for Medical Condition, Date Plan Last Reviewed, History of Medical Condition, When Condition First Diagnosed, Who Diagnosed Condition, Other Information.

3. Allergies

Field: Type of Allergy, Triggers/Warning Signs/Symptoms, Severity of Allergy (mild, moderate, sever, other), Special Requirements (e.g. dietary/must carry medication at all times), Treatment Plan, Date Plan Last Reviewed, History of the Allergy from Diagnosis until Now, When Allergy First Diagnosed, Who Diagnosed Allergy, Other Information

4. General Medical History

Field: Past medical history (dates, surgery)n m, Other relevant history, Blood Type (A+, A−, B+, B−, AB+, AB−, O+, O−)

5. Immunisation History

Field: Type, Date Received

6. Medications

Field: Name, Reason Taken, Quantity, Dosage Unit, Frequency, Route Taken, Date Started, Date Stopped, Reason Stopped, Assistance Required

Online (Web Based) Administration Module

In order to allow registrants and their associated contacts to maintain their data, a web based interface would be developed. The interface will be available for both Essential medical data communication system and identification assist. The following elements will be used in the online updates module:

Critical Details:

(ID & Essential medical data communication system)

Registrant Details: Title, First Name, Middle name, Surname, Nickname, Preferred Name, Gender, Date of Birth, Residential & Mailing Address, Telephone Numbers, Home/Work Email, Bracelet Details, Languages Spoken & Sensory Impairments.

(Essential identification data communication system Only)

Identifying Personal Details (height, weight, etc.), Distinguishing Features, Relevant Life History, Living Arrangements

Contact Details:

(ID & Essential medical data communication system)

Primary & Second Contact Name, Telephone Numbers, Residential and Mailing Address, Home/Work Email, Relationship, If lives with registrant, legal authority status, flags to indicate if person is a contact in emergency, contact for information, or provided registrant details.

(Essential identification data communication system Only)

Caregiver Details

Medical & Diagnostic/Health Management:

Medical Contacts:

(ID & Essential medical data communication system): GP/Specialist/Medical Professionals: Name, Profession/Specialty, Clinic, Address, Phone

Medical Conditions (Multiple):

(Essential identification data communication system): Name, Attention Required

(Essential medical data communication system): Name, Related Conditions, Triggers/Warning Signs/Symptoms, Severity, Special Requirements, Treatment Plan, History, When Diagnosed, Who Diagnosed Condition, Other Information.

Asthma Details

Medications:

(ID & Essential medical data communication system): Name, quantity, dosage unit, frequency, route take, (associated condition), help required

(Essential medical data communication system Only): date started, date stopped, reason stopped

Allergies.

(Essential medical data communication system Only):Type of Allergy, Triggers/Warning Signs/Symptoms, Severity, Special Requirements, Treatment Plan, History, When Diagnosed, Who Diagnosed Allergy, Other Information.

Health Reference Information: Medicare, private health funds, ambulance subscriber

General Medical History:

(Essential medical data communication system Only): Past medical history (dates, descriptions), Other relevant history, blood type

Immunisation History:

(Essential medical data communication system Only): Date(s) Received, Type

Diagnoses:

(Essential identification data communication system Only): Dementia, Psychiatric, Developmental, Other

Activities of Daily Living Restrictions: (Essential identification data communication system Only): Memory, Orientation, Outside Home functioning, Personal Care, Mobility

Behavioural.

Behaviours of Concern: (Essential identification data communication system Only): Behaviour, Management Approach

Details for Approaching Person: (Essential identification data communication system Only): Name to use, discussion topics, approach details, other information

Photo Administration: Photos: Upload / auto generate thumbnail, standard size photo(s)

Auditing: Log username, date/time & task when changes to data occur.

Security: A new role will be incorporated into SRH to facilitate a “master user” from an organisation (e.g. school, Alzheimer's association) to manage (create, edit, view) registrant data. This user will also have the ability to create and maintain logins for users associated with each registrant. The security of this user will be such that they can only view and maintain users, which have been created/associated with their organisation.

Administrators and “organisational master users” will be able to control whether a user can or can't edit a registrant's details.

Police will only be able to view data for registrants subscribed to identification assist who have given authority to do so. Police will not be able to view data for any Essential medical data communication system registrants. Police will not be able to modify any registrant data.

Notes

Users will not be able to register directly online.

Users will need to manually submit the relevant paper-based forms. On receipt of the forms, an administrative person will process them and create a base record in the system for registrant and then assign either the registrant or the primary contact appropriate login credentials for viewing/maintaining registrant data.

### Example H

The Essential data communication system is extended to facilitate the delegation of registrant management to organisations while also empowering registrants and their primary contacts to have more control over their record's privacy and availability.

Web Interface

1. Add/edit an organisation within the system.

This will consist of adding the name, address and contact details for an organisation and assigning the organisation an identification number

2. Create/edit users and associate them with:

a. An organisation:

Each organisation will have users in at least one of the following roles:

Organisation System Admin

Has ability to add and edit (if granted permission by registrant) registrant records, and associated user accounts (logins)

Organisation General User

Ability to access assigned registrant record(s).

Approved Users/Registrants

b. Registrants:

SRH Administrator will be able to edit permissions for each user and what level of access they have to a registrant record.

Access will be controlled on a “per tab” basis.

(Critical Details, Medical & Diagnostic/Health Management, Behavioural, Photos, Contacts, Missing Episodes, Broadcast Alert, Health Notes)

The per tab permissions will mean that for each registrant and tab, a user will have one of the following access levels:

1. No access

2. Read Only Access

3. Read/Write Access

A facility will be made available for an administrative user to filter for a specific user or set of users by name.

MS Access Interface

The admin tool will allow for THE APPLICANT to interface with the data. THE APPLICANT will be able to use this tool to create queries and reports to view statistics about the system, as well as track and manage billing.

Police

Each registrant record has a flag associated with it to indicate whether or not police have access to the record.

If police have access, they will have read access to all tabs except Missing Episodes, which will be read/write.

Organisation System Admin

(e.g. School Central Admin, Aged Care Organisation Admin, Doctors Surgery Admin)

All data accessed by users in this role is limited to the users and registrants within their assigned organisation.

This user will be able to:

1. Create a new registrant record (based on quick registration form)

2. Edit a registrant record (provided registrant has granted appropriate permissions)

3. Can add/edit users within an organisation and associate with a registrant.

a. This includes setting default access permissions for each tab.(Registrant can override whether or not an organisation system admin can associate users with the registrant record)

b. As per the SRH Administrator, this user will be able to search/filter for users by name.

A facility will be made available to search/filter for registrants by name.

Organisation General Users

(e.g. School Teachers, Organisation Nurse)

These are users who will have access to all registrant records within their organisation. These users will by default, have read access to registrant records, however can be overridden by each registrant to either have no access or read/write to specific tabs.

As per the organisation system admin, a facility will be made available to search/filter registrants by name.

Users/Registrants

(e.g. Registrant, Parent, Doctor)

Depending on permissions, approved users can view/edit a registrant record.

Each registrant will have a primary user associated with their record.

This user will be able to associate other users with the registrant's record and assign permissions, per tab, for the record. When another user is to be associated with the registrant, a ticket and/or temporary username/password will be issued to the recipient user. This user will then have to login and complete the process of associating their account with the registrant.

The primary user can also associate/disassociate the record from viewing by Police and request to be disassociated with current organisation

Permissions for organisation system administrators and organisation general users will be controlled for each of the two roles (not individual users within the roles).

All users and registrants will be assigned to a default organisation. The default organisation will be THE APPLICANT, unless entered under another organisation (e.g. school).

All Users/Roles

An online form, based on the PDF/paper Quick registration form, will be created to allow administrators and new users to enter the required information in order to create a base record in the system and an associated username/password. New users who complete this form will need to be approved by an organisational or system admin before the record becomes active, however, records entered by administrators will be automatically approved.

Component Development Summary

Organisations

Add/Edit Organisation Details (name, address, etc)

Display information about which organisation a particular user/registrant belongs to.

Web form to allow users to submit a request to disassociate themselves from their current Organisation.

User Management and Security Enhancements

Addition of new roles

Facility to filter list of users by name

Associate user with an organisation

Ability for new users to create a username/password

Security checks to allow/disallow users to view/modify various sections of the system and associated data.

Registrant Admin

Facility to search/filter registrants by name for administrators

Registration—Quick registration form to allow base record of minimal details to be quickly created

User/Registrant Association

Associate user accounts with a registrant record

Set permissions for which tabs a user can see on each registrant record

Essential medical data communication system—Add a new “Health Notes” tab.

This tab will consist of a list of entries entered by a registrant (or associated user).

Each entry can be added/edited/deleted and will consist of: date, text and user who created/last modified.

Name Changes

After an initial record has been created for a registrant, name changes will only be possible via a formal request to THE APPLICANT (web form). This is to prevent “cheating” the system by replacing one registrant with another.

National Urgency Rating

Add a facility in the episode reports to perform a search urgency assessment and then storing and displaying the calculated values. The rating facility will capture the following pieces of information: subject profile, clothing profile, equipment profile, experience profile, weather profile and terrain and hazardous profile.

This will be based on the “Victoria Police Search and Rescue Squad Information Management System” documents.

Demo Version

Split the SRH system into two versions, production and demonstration.

The production system will house all live registrations and real data only.

The demonstration system will be an identical copy of the production system. However, it will be using fictional data.

This will require some minor modifications to the application (e.g. removing test text after names, http/https switching) as well as graphical changes to ensure both versions are clearly distinguishable.

Perform data load of police user data.

Note: The scripts created to import the data into the demo system will also be able to be used for import into the production system.

### Example I

The Essential data communication system has been extended to facilitate the delegation of registrant management to organisations while also empowering registrants and their primary contacts to have more control over their record's privacy and availability.

Web Interface

3. Add/edit an organisation within the system.

This will consist of adding the name, address and contact details for an organisation and assigning the organisation an identification number

4. Create/edit users and associate them with:

a. An organisation:

Each organisation will have users in at least one of the following roles:

Organisation System Admin

Has ability to add and edit (if granted permission by registrant) registrant records, and associated user accounts (logins)

Organisation General User

Ability to access assigned registrant record(s).

Approved Users/Registrants

b. Registrants:

SRH Administrator will be able to edit permissions for each user and what level of access they have to a registrant record.

Access will be controlled on a “per tab” basis.

(Critical Details, Medical & Diagnostic/Health Management, Behavioural, Photos, Contacts, Missing Episodes, Broadcast Alert, Health Notes)

The per tab permissions will mean that for each registrant and tab, a user will have one of the following access levels:

1. No access

2. Read Only Access

3. Read/Write Access

A facility will be made available for an administrative user to filter for a specific user or set of users by name.

MS Access Interface

The admin tool will allow for THE APPLICANT to interface with the data.

THE APPLICANT will be able to use this tool to create queries and reports to view statistics about the system, as well as track and manage billing.

Police

Each registrant record has a flag associated with it to indicate whether or not police have access to the record.

If police have access, they will have read access to all tabs except Missing Episodes, which will be read/write.

Organisation System Admin

(e.g. School Central Admin, Aged Care Organisation Admin, Doctors Surger Admin)

All data accessed by users in this role is limited to the users and registrants within their assigned organisation.

This user will be able to:

4. Create a new registrant record (based on quick registration form)

5. Edit a registrant record (provided registrant has granted appropriate permissions)

6. Can add/edit users within an organisation and associate with a registrant.

c. This includes setting default access permissions for each tab.(Registrant can override whether or not an organisation system admin can associate users with the registrant record)

d. As per the SRH Administrator, this user will be able to search/filter for users by name.

A facility will be made available to search/filter for registrants by name.

Organisation General Users

(e.g. School Teachers, Organisation Nurse)

These are users who will have access to all registrant records within their organisation. These users will by default, have read access to registrant records, however can be overridden by each registrant to either have no access or read/write to specific tabs.

As per the organisation system admin, a facility will be made available to search/filter registrants by name.

Users/Registrants

(e.g. Registrant, Parent, Doctor)

Depending on permissions, approved users can view/edit a registrant record.

Each registrant will have a primary user associated with their record.

This user will be able to associate other users with the registrant's record and assign permissions, per tab, for the record. When another user is to be associated with the registrant, a ticket and/or temporary username/password will be issued to the recipient user. This user will then have to login and complete the process of associating their account with the registrant.

The primary user can also associate/disassociate the record from viewing by Police and request to be disassociated with current organisation

Permissions for organisation system administrators and organisation general users will be controlled for each of the two roles (not individual users within the roles).

All users and registrants will be assigned to a default organisation. The default organisation will be THE APPLICANT, unless entered under another organisation (e.g. school).

All Users/Roles

An online form, based on the PDF/paper Quick registration form, will be created to allow administrators and new users to enter the required information in order to create a base record in the system and an associated username/password.

During the registration process, users will also be required to complete an online consent form, based on the PDF/paper version.

New users who complete the quick registration and online consent form will be active for a grace period of 30 days, during which time they will be required to submit payment and a paper based consent form.

Registrants in a grace period will be unable to export or email data and will have no access to create or email missing episode reports and broadcast alerts.

Once the appropriate paperwork and payments are received, an organisational admin or system admin can “approve” the record thereby making it active for a designated subscription period.

Component Development Summary

Organisations

Add/Edit Organisation Details (name, address, etc)

Display information about which organisation a particular user/registrant belongs to.

Web form to allow users to submit a request to disassociate themselves from their current organisation.

User Management and Security Enhancements

Addition of new roles

Facility to filter list of users by name

Associate user with an organisation

Ability for new users to create a username/password

Security checks to allow/disallow users to view/modify various sections of the system and associated data.

Registrant Admin

Facility for administrators to search/filter registrants by name

Registration

Quick registration form to allow base record of minimal details to be quickly created Online consent form

User/Registrant Association

Associate user accounts with a registrant record

Set permissions for which tabs a user can see on each registrant record

Essential medical data communication system—Add a new “Health Notes” tab.

This tab will consist of a list of entries entered by a registrant (or associated user).

Each entry can be added/edited/deleted and will consist of: date, text and user who created/last modified.

Name Changes

After an initial record has been created for a registrant, name changes will only be possible via a formal request to THE APPLICANT (web form). This is to prevent “cheating” the system by replacing one registrant with another.

Police Data Import

Modify Safe Return application to cater for users without email addresses.

Perform data load of Tasmanian police user data.

Note: File consists of Surname, Given name(s), badge number & email (optional)

Medical and Diagnostic

Incorporate changes to mobility information stored and displayed.

i.e. Ability to Ambulate/Travel Distances, Walking and Agility Rating, Transport Use & Access Rating

Missing Episodes and Broadcast Alerts

Modify episode report screen to allow for users to generate an alert without necessarily completing specific details about an episode.

Remove compulsory status on Last seen and Reported Missing dates and Reported By Name

Move approval status options to the top of the page to allow a quick alert generation.

### Example J

The Essential medical data communication system module of Essential data communication system is enhanced to capture and display additional health related data.

Medical Conditions

This will be a summary list of medical conditions associated with a registrant.

This summary will comprise of: Condition Name, Current Health Issue (y/n), link to management plan & Date Last Reviewed

A mechanism to associate different conditions with specific management plans is to be considered.

In this enhancement, there will only be two plans, an asthma plan and a generic plan.

To accommodate the distinction of asthma as a specific medical condition:

The current medical management plan will be modified so that the sub-section “Usual Asthma Management Plan” is removed.

A new asthma plan will be created.

Allergies

This will be a summary list of allergies associated with a registrant.

This summary will comprise of: Condition Name, Current Health Issue (y/n), link to management plan & Date Last Reviewed

Allergies listed here will link to an allergy management plan.

Medications

Each medication listed is to display and store the following extra fields:

Medication Type (e.g. tablet, liquate, inhaler, patch, injection)

Instructions for taking

Immunisations History

The list of immunisations is to be expanded to capture the following pieces of additional information:

Immunisation Stage (options: one off, booster, series (first, second, third))

Date Next Shot Due

It should be understood that the invention is not limited to the particular embodiments disclosed. Clearly persons skilled in the art would understand variations without any undue inventiveness and such is included within the scope of the invention as defined within the scope of the following claims.

1. An essential data communication system for allowing controlled access or communication of essential data of each of a multiple number of users including the steps of:
the user defining an input of essential data and the user defining a control restriction of access to the user's defined essential data;
collating the essential data of multiple users including each user defined control restriction of access to each user's defined essential data, and
communicating or allowing access to a user's defined essential data in accordance with the user's defined control restriction of access to the user's defined essential data.

2. An essential data communication system according to claim 1 wherein the essential data is identification data.

3. An essential data communication system according to claim 1 wherein the essential data is identification and medical data.

4. An essential data communication system according to claim 1 wherein the user defined control restriction of access to said defined essential data includes automatic selection of access by emergency services including police, ambulance and hospital.

5. An essential data communication system according to claim 1 wherein the user defined control restriction of access to said defined essential data includes selection of access by defined persons.

6. An essential data communication system according to claim 5 wherein the defined persons are a caregiver or selected medical practitioner.

7. An essential data communication system according to claim 5 wherein the defined persons include an authorised person of an organisation such as school or association.

8. An essential data communication system according to claim 1 wherein the user defined control restriction of access to said defined essential data includes a predefined event that is defined by one or more conditions or circumstances of the user.

9. An essential data communication system according to claim 8 wherein the conditions or circumstances of the user include any one or more of medical disability, being reported lost, disorientated or otherwise incapacitated.

10. An essential data communication system according to claim 9 wherein the conditions or circumstances of the user is automatically assessed.

11. An essential data communication system according to claim 10 wherein the conditions or circumstances of the user is assessed from an evaluation of essential data recorded.

12. An essential data communication system according to claim 8 wherein the conditions or circumstances of the user is assessed from external inputs.

13. An essential data communication system according to claim 1 wherein the user defined control restriction of access to said defined essential data includes selecting defined persons able to add or modify the user's essential data.

14. An essential data communication system according to claim 13 wherein the user automatically defines general authorised persons able to add or modify the user's essential data.

15. An essential data communication system according to claim 12 including recordal of occurrence of access to or communication of the user's essential data.

16. An essential data communication system according to claim 15 including maintaining changes of user's essential data and recordal of said changes for display.

17. An essential data communication system according to claim 16 wherein the conditions or circumstances of the user is assessed from an evaluation of the change in essential data recorded.

18. An essential data communication system according to claim 16 wherein the conditions or circumstances of the user is assessed from an evaluation of the change in essential data recorded.

19. An essential data communication system according to claim 12 wherein dependent on the conditions or circumstances of the user as assessed a form of the user's essential data is communicated to the user.

20. An essential data communication system according to claim 1 wherein dependent on the conditions or circumstances of the user as assessed a defined form of the user's essential data is communicated to a person defined in the user's defined control restriction of access to the user's defined essential data.

21. An essential data communication system according to claim 1 wherein dependent on the conditions or circumstances of the user as assessed a defined form of the user's essential data is selectively broadcast to a defined person, association or emergency service defined in the user's defined control restriction of access to the user's defined essential data.

22. An essential data communication system according to any one of claims 1 to 18 wherein dependent on the conditions or circumstances of the user as assessed a defined form of the user's essential data is broadcast to a widely accessible or viewable medium defined in the user's defined control restriction of access to the user's defined essential data.

23. An essential data communication system forming a safety mechanism for people likely to be disorientated or lost, the method including the steps of:
a user providing personal details of the user;
the user authorising recording of the personal data in one or more forms of personal data files having varying amount of details;
the user defining an access restriction to each of the one or more forms of the recorded personal data files respectively;
at least one of the access restrictions including a predefined event that is not time defined but defined by one or more conditions or circumstances of the user.

24. An essential data communication system according to claim 23 wherein an authorised person can access a particular authorised form of the personal data files of the user dependent upon the occurrence of the predefined event and therefore the user has control of dissemination of the user's personal details when the condition or circumstance of the user as the time warrants such dissemination.

25. An essential data communication system according to claim 23 wherein an authorised person can access a particular authorised form of the personal data files of the user dependent upon the level of access defined by the user and therefore the user has control of dissemination of the user's personal details when the condition or circumstance of the user as the time warrants such dissemination.

26. An essential data communication system according to claim 23 wherein an access record is created to record the access to the user's personal details by authorised person and the access record being accessible by the user such that the user has control and information of the dissemination of user's personal details.

27. An essential data communication system for communicating a user's essential data to other parties including the following steps:
a step of essential data collection which includes the user defining an input of essential data, and
a step of dissemination of said defined essential data, which includes a user defined control restriction of access to said, defined essential data;
wherein the access restriction includes a predefined event that is defined by one or more conditions or circumstances of the user including any one or more of medical disability, being reported lost, disorientated or otherwise incapacitated; and
wherein the dissemination step includes the user having an identity means which records an access address of the recorded personal data files and an authorising code being available such that an authorised person can use the code to access the user's personal data files and thereby assist the user in need while the user still maintains control of the personal data files and access by the predefined access restrictions.

28. The essential data communication system according to claim 27 wherein the dissemination step includes defining a form of personal data file and authorising a particular form of broadcast on a public medium of that personal data file on the instigation of an event predefined by the user.

29. An essential data communication system according to claim 28 wherein the predefined event is when a caregiver or authorised person notifies that the user is lost or disorientated.

30. An essential data communication system of a user's essential data by other parties including the user defining an input of essential data on a database having secured access, and including broadcast means associated with said database and being operative to allow automatic selective broadcast of a predefined personal data file of the user's defined essential data when a user defined condition is fulfilled.

31. An essential data communication system according to claim 30 with the condition including overriding user defined conditions and any other required conditions after which selective broadcast is to be allowed.

32. An essential data communication system according to claim 31 wherein the condition includes an authorisation of any editing of the information on behalf of the user.

33. An essential data communication system according to claim 32 wherein the condition includes a geographical limitation of the broadcast or the locations from which authorised access is allowable.

34. An essential data communication system according to claim 32 wherein selective broadcast is to a defined medical access database able to be accessed by authorised medical personnel or to a defined police broadcast or internal communication of Police network.

35. A computer program product for use in essential data communication system with input means accessible by a user enabling the user to record personal essential data and to provide an access restriction associated with said recorded personal essential data which limits access to authorised person and user defined event definition that is not time defined but defined by one or more conditions or circumstances of the user wherein an authorised person can access the authorised form of the personal data files of the user defined essential data upon the occurrence of the predefined event and therefore the user has control of dissemination of the user's personal details when the condition or circumstance of the user at the time warrants such dissemination.

36. A computer program product for use in essential data communication system with connection to a predefined communications network with the program providing an defined form of personal data file and authorise a particular form of broadcast of that personal data file on the instigation of an event predefined by the user including the event when a caregiver or authorised person notifies that the user is lost or disorientated.
